(19) United States
(12) Patent Application Publication
(10) Pub. No.: US 2020/0314621 A1
(43) Pub. Date: Oct. 1, 2020

(54) SYSTEM, METHOD AND COMPUTER PROGRAM PRODUCT FOR CONVEYING DATA GENERATED ON-BOARD VEHICLES TO REMOTE LOCATIONS

(71) Applicant: SAVERONE 2014 LTD., Petah-Tikva (IL)

(72) Inventors: Yossef COHEN, Hod Hasharon (IL); Amiram GUR GERASI, Ganey Tikva (IL); Amir LAVI, Rehovot (IL)

(21) Appl. No.: 16/306,932

(22) PCT Filed: Jun. 6, 2017
(86) PCT No.: PCT/IL2017/050636

§ 371 Date: Dec. 4, 2018

Related U.S. Application Data
(60) Provisional application No. 62/345,911, filed on Jun. 6, 2016.
(60) Provisional application No. 62/396,537, filed on Sep. 19, 2016.

(51) Int. Cl. H04W 4/90; H04W 76/50; H04W 4/44; H04W 8/00

(52) U.S. Cl. CPC H04W 4/90; H04W 8/005; H04W 4/44; H04W 76/50

(57) ABSTRACT

A system for conveying data generated on-board a vehicle, from the vehicle to at least one remote location/s, the system comprising an on-board data monitoring processor which receives data from at least one data-generating source including at least one vehicle-mounted data-generating source; and/or a controller which is operative, at least on occasion, to scan the vehicle for mobile communication devices thereby to identify at least one mobile communication device temporarily within the vehicle's range and to trigger at least one mobile communication device thus identified to convey at least some of the data received from the at least one source to at least one remote destination.

### REFERENCE TO CO-PENDING APPLICATIONS

The disclosure of PCT/IL2015/050630, entitled “System and Methods to Facilitate Safe Driving” filed Jun. 22, 2015 and published as WO 2015198306, and of the publications and patent documents cited therein directly or indirectly, are hereby incorporated by reference. Priority is claimed from United States Provisional Patent Applications No. 62/345,911 filed Jun. 6, 2016 and 62/396,537 filed Sep. 19, 2016 both entitled “System For Automatically Alerting An Emergency Care Center Of A Traffic Accident”, the disclosure of both applications being hereby incorporated by reference.

### FIELD OF THIS DISCLOSURE

The present invention relates generally to data communication systems and more particularly to systems for alerting regarding emergency situations.

### BACKGROUND FOR THIS DISCLOSURE

The average number of road accident victims in the US and Europe is hundreds of thousands each year. Of these, in the United States about 42,000 people are killed each year, and hundreds of thousands more are left with permanent injuries of varying severity. Despite the level of protection of vehicles, as well as the increased quality of safety accessories (seatbelts, airbags, air pressure sensors etc.), the most significant parameter determining how badly victims are affected by accidents depends on the speed of assistance they receive immediately following such occurrences. Medical care for victims of road accidents during the first hour following an accident, known as the “golden hour”, is decisive in saving lives of such victims. The chance of recovery has been estimated to be up to 80% for patients that receive treatment within this crucial time.

Systems for initiating Emergency Calls (eCall) from vehicles upon identifying emergency situations are known. Such systems usually obtain information from the vehicle On-Board Diagnostic interface (OBD-II), perform algorithmic calculation on the data, and upon reaching a decision that there is an emergency situation, initiate a call and/or send data to a predefined emergency center.

Other solutions are mobile applications like BikerSOS, Cradar, Xemplar Crash Detection, SafeTrip SMS Crash Detection that may use mobile sensors and have a built-in decision mechanism to initiate a call to the emergency center.

Federal Communications Commission regulations state that all cell phone providers must take emergency calls from any cell phone even those lacking an active service contract or “live” phone number. However, calling in an emergency from a cellphone is said to slow down the response time of emergency personnel. This is because legacy emergency call technology, developed before cell phones were invented, provides the caller's address if the call comes in over a landline but is unable to do so for a caller using her or his cell phone.

Regarding vehicular emergencies, it has been proposed to equip vehicles with a modem, e.g. as described at the following http://www links: 3gpp.org/technologies/keywords-acronyms/107-ecall or sensalink.com.au.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments seek to provide a system for automatically alerting an emergency center of a traffic accident.

Certain embodiments seek to provide a method for initiating a cellular call and/or transmitting required data in an emergency situation.

Certain embodiments seek to provide a system for automatic transmission of emergency calls (eCalls).

Certain embodiments seek to provide a system for contacting a center and gathering relevant data from various sources in an emergency situation.

Certain embodiments seek to utilize a legacy vehicle interface and/or legacy sensors, to apply an emergency decision algorithm and to use a driver's cellphone to communicate with the emergency center.

Certain embodiments seek to utilize the vehicle interface and available sensors, apply the emergency decision algorithm, and use the driver's cellphone to communicate with the emergency center. This embodiment may offer lower CapEx. of the vehicle SIM and no OpEx of the contracting with a cellular carrier and monthly payments.

Certain embodiments seek to provide a system for contacting a center e.g. to facilitate rapid rescue and/or rapid documentation of vehicle and/or driver/passenger condition, in an emergency situation.

Certain embodiments seek to provide a system for obtaining statistical information regarding the driver actions prior to the emergency situation and providing this data to at least one remote location e.g. emergency center.

Certain embodiments seek to provide a system for obtaining data from various sources relevant to the time stamp of the occurrence of the emergency situation and providing this data to at least one remote location e.g. emergency center.

Certain embodiments seek to provide a system for transmitting or otherwise conveying data, generated on-board a moving, or stationary platform such as a vehicle or other moving or stationary object or site, from the platform to at least one location/s remote from the platform, the system comprising:

An on-board data monitoring processor which receives data from at least one data-generating source including at least one source on-board the platform e.g. vehicle-mounted data-generating source; and

a controller which is operative, at least on occasion, to scan the platform's vicinity for mobile communication devices thereby to identify at least one mobile communication device temporarily within the platform's range e.g. temporarily on or in or on-board or adjacent the platform and to trigger at least one mobile communication device thus identified to convey at least some of the data received from the at least one source to at least one remote destination.

It is appreciated that references here and elsewhere to mobile communication devices temporarily within the vehicle's range need not only include those mobile communication devices which are temporarily on-board the vehicle e.g. those borne by the vehicle's passengers including driver, and may also include device/s which are adjacent the vehicle e.g. in neighboring vehicles or borne by pedestrians, and are still within range.
Certain embodiments of the present invention, e.g. the above, are operative in conjunction with one some or all of:
a system to locate a wireless device in a volume;
calibration methods for calibrating such systems. Calibration may employ a default configuration, and/or manual calibration may occur per vehicle and an automatic method may optionally be used to update the calibration parameters;
localization inside a predefined volume (such as a room, a vehicle, a cabin, a train);
localization inside a volume inhabited by moving objects, such as persons who come and go, or remain at one position but move their limbs;
a system and method to locate (aka localize) modern wireless devices when power control is enabled;
a method, using information in the control channel, to determine the exact transmission power of a device;
a method to locate a wireless device that supports power control without using power information in the control channel e.g. to determine the exact transmission power of a device;
reference antenna which provides indications of when and how transmission power is changing;
a localization system for locating a wireless device e.g. cellphone with power control enabled in a vehicle, without using any information from the control channel.

The scope of the system described herein may include at least the following variants and embodiments, each of which may be provided in combination with other variants and embodiments as shown and described herein:

Embodiment a1: A system for localizing a transmitting wireless device within a known volume, the system comprising:

N>=2 antennae deployed in N>=2 respective locations at least some of which are located within the known volume, each of the antennae being operative to receive and output a signal from the transmitting wireless device;

at least one analog-to-digital converter operative to convert analog received signals at the output of the antennae to digital sampled received signals; and

a processor operative:

to receive the digital sampled received signals and to compute at least one real time output parameter comprising a predetermined function of
digitally sampled received signals S, received from the transmitting wireless device at antenna i; and of digitally sampled signals, received from the transmitting wireless device at antenna j and digitally sampled, simultaneously with reception at antenna i and digital sampling of the digitally sampled received signals S,

whose predetermined function is independent of a power level at which the transmitting device is transmitting,

and to estimate the transmitting wireless device's location within the volume by comparing the at least one real time output parameter to plural reference output parameters respectively having a known correspondence to plural known possible locations within the volume respectively, for at least one pair of antennae i, j from among the N antennae.

Embodiment a2. A system according to any of the preceding embodiments wherein the function comprises a ratio between:

quality of reception of transmission from the transmitting wireless device at antenna i; and simultaneous quality of reception of transmission from the transmitting wireless device at antenna j.

Embodiment a3. A system according to any of the preceding embodiments wherein the function comprises a probability density function of a ratio between: quality of reception of transmission from the transmitting wireless device at antenna i; and simultaneous quality of reception of transmission from the transmitting wireless device at antenna j.

Embodiment a4, A system according to any of the preceding embodiments wherein the quality of reception comprises a power level measurement.

Embodiment a5. A system according to any of the preceding embodiments wherein the power level measurement comprises an RSSI value.

Embodiment a6. A system according to any of the preceding embodiments wherein the transmitting wireless device comprises a cellular device transmitting to a base station other than the N antennae.

Embodiment a7. A system according to any of the preceding embodiments wherein the known volume is within a vehicle and the antennae are deployed onboard the vehicle.

Embodiment a8. A system according to any of the preceding embodiments wherein the vehicle has an interior defining 4 corners and the antennae are deployed at least at the 4 corners.

Embodiment a9. A system according to any of the preceding embodiments wherein the vehicle has an interior defining 4 corners and the antennae are deployed at least at some of 4 corners.

Embodiment a10. A system according to any of the preceding embodiments wherein the transmitting device is transmitting to a stationary base station external to the vehicle which is moving.

Embodiment a11. A system according to any of the preceding embodiments wherein the plural reference outputs are each previously learned by computing an output being the predetermined function of:

quality of reception of radiation at antenna i, from a transmitting device deployed at a known location within the volume; and of

simultaneous quality of reception of radiation from the transmitting device at antenna j from the transmitting device deployed at the known location.

Embodiment a12. A system according to any of the preceding embodiments wherein the location is estimated by finding plural weights which minimize distance between:

weighted combinations, based on the weights, of the plural reference outputs, and between the real time output, and computing a location which is a weighted combination of the plural locations, using the plural weights which minimize distance.

Embodiment a13. A system according to any of the preceding embodiments wherein the probability density function comprises a probability density function over time.

Embodiment a14. A system according to any of the preceding embodiments wherein the probability density function comprises a probability density function over frequency.

Embodiment a15. A system according to any of the preceding embodiments wherein the comparing comprises computing plural distances between the at least one real time output and each of the plural reference outputs respectively.

Embodiment a16. A system according to any of the preceding embodiments wherein at least one of the distances is computed using least squares technology.

Embodiment a17. A system according to any of the preceding embodiments wherein at least one of the distances is computed by integrating a maximum function of the outputs.

Embodiment a18. A system according to any of the preceding embodiments wherein the at least one pair of antennae comprises multiple pairs.

Embodiment a19. A system according to any of the preceding embodiments wherein the transmitting device is to be localized within a sub-region inside the volume, and wherein the antennae includes at least first and second antennae (“main antennae”) deployed within the sub-region and at least one “reference”) antenna deployed externally to the sub-region and wherein the multiple pairs of antennae each include one of the antennae within the sub-region and one of the antennae deployed externally to the sub-region.

Any suitable criteria may be used for deploying the antennae. For example, if a transmitting device is to be localized within a sub-region inside the volume, the antennae may be distributed throughout the volume, or may be distributed mostly within the sub-region apart from one or a few “reference antennae”. Alternatively or in addition, antennae may be distributed at locations at which the transmitting device is likely to be present e.g, adjacent to a fixed cradle configured to receive the transmitting device. Any suitable number of antennae may be employed, such as 3-7 antennae within the driver's quadrant and 1 or more antennae outside that quadrant. For example, 2 antennae may be deployed adjacent the driver's and passenger's out-facing legs respectively, a third antenna may be deployed intermediate the first 2 i.e. adjacent driver's and passenger's in-facing legs, and a fourth antenna may be deployed adjacent the driver's head i.e. to the rear of the first antenna. It is appreciated that all of these antennae other than the third may be mounted on the car interior's inner side walls.

More generally, typically some locations are within a subregion of interest such as a driver's seat or quadrant, and others of the location are external to the subregion, so as to sample both subregion and its exterior, during training. For example, if 13 locations are employed, 7 may be within the subregion and 6 externally thereto.

Embodiment a20. A system according to any of the preceding embodiments wherein the known volume is within a vehicle and the sub-region comprises a quadrant of the vehicle including the driver's seat.

Each antenna may have a reception range of approximately 20-30 cm.

Embodiment a21. A system according to any of the preceding embodiments wherein the system also comprises a computerized service provider configured to selectably provide at least one service unsuitable for an end-user who is driving, depending on whether or not the transmitting device is located within the quadrant of the vehicle including the driver's seat.

Embodiment a22. A system according to any of the preceding embodiments wherein the function comprises a multi-dimensional probability density function of multiple functions each of the multiple functions relating quality of reception of radiation from the transmitting device at antenna i; to simultaneous quality of reception of radiation from the transmitting device at antenna j, for a different pair from among the multiple pairs (i, j) respectively.

For example, if 3 main antennae a, b, c are deployed in the driver's quadrant (the portion of the vehicle's interior which is allocated to the driver as opposed to the quadrants allocated to passengers) and 1 reference antenna r is deployed externally to the driver's quadrant, a 3-dimensional PDF may be employed representing probability distribution over 3 ratios, e g. quality of reception of radiation from the transmitting device at antenna a/simultaneous quality of reception of radiation from the transmitting device at antenna r;

quality of reception of radiation from the transmitting device at antenna b/simultaneous quality of reception of radiation from the transmitting device at antenna r;

quality of reception of radiation from the transmitting device at antenna cl simultaneous quality of reception of radiation from the transmitting device at antenna r.

Embodiment a 23. A method for localizing a transmitting wireless device within a known volume, the method comprising:

providing N>=2 antennae deployed in N>=2 respective locations at least some of which are located within the known volume, each of the antennae being operative to receive and output a signal from the transmitting wireless device and at least one analog-to-digital converter operative to convert analog received signals at the output of the antennae to digital sampled received signals; and using a processor to receive the digital sampled received signals and to compute at least one real time output parameter comprising a predetermined function of: digitally sampled received signals S, received from the transmitting wireless device at antenna i; and of digitally sampled signals, received from the transmitting wireless device at antenna j and digitally sampled, simultaneously with reception at antenna I and digital sampling of the digitally sampled received signals S, whose predetermined function is independent of a power level at which the transmitting device is transmitting, and to estimate the transmitting wireless device's location within the volume by comparing the at least one real time output parameter to plural reference output parameters respectively having a known correspondence to plural known possible locations within the volume respectively, for at least one pair of antennae i, j from among the N antennae.

Embodiment a24. A computer program product, comprising a non-transitory tangible computer readable medium having computer readable program code embodied therein, the computer readable program code adapted to be executed to implement a method for localizing a transmitting wireless device within a known volume, the method being practiced in conjunction with N>=2 antennae deployed in N>=2 respective locations at least some of which arc located within the known volume, each of the antennae being operative to receive and output a signal from the transmitting wireless device and with at least one analog-to-digital converter operative to convert analog received signals at the output of the antennae to digital sampled received signals, the method comprising: using a processor to receive the digital sampled. received signals and to compute at least one real time output parameter comprising a predetermined function of digitally sampled received signals S, received from the transmitting wireless device at antenna i; and of digitally sampled signals, received from the transmitting wireless device at antenna j and digitally sampled, simultaneously with reception at antenna I and digital sampling of the digitally sampled received signals S, whose predetermined function is independent of a power level at which the transmitting device is transmitting, using a processor to estimate the transmitting wireless device's location within the volume by comparing the at least one real time output parameter to plural reference output parameters respectively having a known correspondence to plural known possible locations within the volume respectively, for at least one pair of antennae i, j from among the N antennae.

The scope of the present invention may also include at least the following: embodiments, each typically in combination with other embodiments as shown and described herein including the above listed embodiments:

Embodiment b1. A system for automatically contacting at least one emergency center, the system comprising:

call decision software which receives data from at least one vehicle-mounted source and determines, based at least partly on at least some of the data, whether or not an emergency situation is present;

an SCU which is operative, if an emergency situation is detected, to connect to a driver's mobile device and to send a signal, to an eCall mobile application residing on the driver's mobile device which is connected to a cellular network, instructing the eCall mobile application to contact at last one designated emergency center, via the cellular network.

Embodiment b2. A system according to any of the preceding embodiments wherein the SCU is operative, if and only if an emergency situation is detected, to connect to the driver's mobile device or any other mobile phone equipped with the SaverOne application and to send a signal, to the eCall mobile application residing on the driver's mobile device, instructing the eCall. mobile application to contact at last one designated emergency center, via the cellular network.

Embodiment b3. A system according to any of the preceding embodiments wherein the SCU is operative to connect to any of the vehicle passengers' mobile devices via a communication method.

Embodiment b4. A system according to any of the preceding embodiments wherein the eCall mobile application is instructed to initiate a call to at least one designated emergency center.

Embodiment b5. A system according to any of the preceding embodiments wherein the eCall mobile application is instructed to send an emergency digital message to at least one designated emergency center.

Embodiment b6. A system according to any of the preceding embodiments wherein the digital message includes at least one parameter to assist the emergency center with evaluating event severity.

Embodiment b7. A system according to any of the preceding embodiments wherein the digital message includes at least one of these parameters: location, last known speed of the vehicle in the last pre-defined number of seconds, acceleration in the last pre-defined number of seconds, vehicle make, vehicle registration number, time stamp, driver's phone ID, and parameters from the vehicle's sensors.

Embodiment b8 A system according to any of the preceding embodiments wherein the decision software receives redundant data from plural sources thereby to increase reliability of data hence reliability of the software's decisions.

Embodiment b9. A system according to any of the preceding embodiments wherein the plural sources include an interface to the vehicle's computers e.g. OBD and a vehicle-mounted SCU.

Embodiment b10. A system according to any of the preceding embodiments wherein the decision software receives data from the interface to the vehicle's computers.

Embodiment b11. A system according to any of the preceding embodiments wherein the decision software receives at least one of location data, acceleration data, and speed data from at least one of:

interface to the vehicle's computers, a vehicle-mounted SCU, and at least one mobile communication device.

Embodiment b12. A system according to any of the preceding embodiments wherein the data includes at least one of: direction, front/side collision, rollover, safety belt, air bags, lane shifting, collision warning' ESP (Electronic Stability System).

Embodiment b13. A system according to any of the preceding embodiments wherein a vehicle-mounted SCU on occasion, e.g. periodically, uses the SaverOne mobile application and the sensors to verify Ecall functionality by checking that (a) the driver's cellphone is in data communication with the SCU and (b) that the eCall mobile application is running on the mobile phone.

Embodiment b14.A system according to any of the preceding embodiments wherein at least if the driver's cellphone is not in communication with the SCU, an alert is provided e.g. an audible alarm.

Embodiment b15. A system according to any of the preceding embodiments wherein at least if the eCall mobile application is not running on the driver's mobile phone, an alert is provided e.g. an audible alarm.

Embodiment b16. A system according to any of the preceding embodiments and also comprising a table of contact information for plural emergency centers in plural areas such that depending on the vehicle's known location, an appropriate one of the plural emergency centers can be called, for example to increase probability that rescue will occur during the “golden hour”.

Embodiment b17. A system according to any of the preceding embodiments wherein the decision is also based on data from G sensors mounted on at least one mobile device in the car.

Embodiment b18. A system according to any of the preceding embodiments wherein the app is activated automatically as above only when the phone is detected, by a vehicle-mounted detection system, to be in a vehicle.

Embodiment b19. A system according to any of the preceding embodiments wherein the app is activated automatically as above only when the phone is detected, by a vehicle-mounted detection system, to be in the driver's quadrant of the vehicle.

Embodiment b 20. A system according to any of the preceding embodiments wherein the app is activated automatically as above only when the vehicle is detected to be moving.

Embodiment b21. A system according to any of the preceding embodiments wherein the system herein is installed in a legacy vehicle with no in-vehicle SIM.

Embodiment b22. A system according to any of the preceding embodiments wherein the app is activated automatically as above only when the phone is detected, by a vehicle-mounted detection system, to be in a vehicle and only when the vehicle is moving.

Embodiment b23, A system according to any of the preceding embodiments wherein the designated emergency center comprises a center for documenting at least one outcome of a traffic accident such as damage to the vehicle.

Embodiment b24. A system according to any of the preceding embodiments wherein the parameter to assist the emergency center with evaluating event severity is used for prioritization of emergency situations competing for scarce resources.

Embodiment b25. A method operating or providing any of the above systems.

The scope of the present invention may also include at least the following: embodiments, each typically in combination with other embodiments as shown and described herein including the above listed embodiments:

Embodiment c1. A system for conveying data generated on-board a vehicle, from the vehicle to at least one remote location's, the system comprising:

An on-board data monitoring processor which receives data from at least one data-generating source including at least one vehicle-mounted data-generating source; and

a controller which is operative, at least on occasion, to scan the vehicle for mobile communication devices thereby to identify at least one mobile communication device temporarily within the vehicle's range and to trigger at least one mobile communication device thus identified to convey at least some of the data received from the at least one source to at least one remote destination.

Embodiment c2. A system according to any of the preceding embodiments wherein the data which at least one mobile communication device is triggered to convey, comprises an indication that an emergency has occurred.

Embodiment c3, A system according to any of the preceding embodiments wherein the data which at least one mobile communication device is triggered to convey, comprises an indication of emergency type e.g. deceleration, airbag activation, vehicle overturned.

Embodiment c 4. A system according to any of the preceding embodiments wherein the data which at least one mobile communication device is triggered to convey, comprises a time-stamp characterizing at least one event relevant to the emergency.

Embodiment c5. A system according to any of the preceding embodiments wherein the data which at least one mobile communication device is triggered to convey, comprises a location relevant to the emergency.

Embodiment c6. A system according to any of the preceding embodiments wherein the data which at least one mobile communication device is triggered to convey, comprises an estimated number of mobile communication devices in the vehicle.

Embodiment c7. A system according to any of the preceding embodiments wherein the data which at least one mobile communication device is triggered to convey, comprises vehicle diagnostic data.

Embodiment c8. A system according to any of the preceding embodiments wherein the processor repeatedly determines, based at least partly on at least some of the data, what data to convey if at all.

Embodiment c9. A system according to any of the preceding embodiments wherein one occasion on which the controller is operative to scan the vehicle is that the processor made a determination that data should be conveyed to the remote location/s.

Embodiment c10. A system according to any of the preceding embodiments wherein the controller is operative to scan the vehicle only when the processor has made a determination that data should be conveyed to the remote location's.

Embodiment c11. A system according to any of the preceding embodiments wherein one occasion on which the controller is operative to trigger at least one mobile communication device to convey data is that the processor made a determination that data should be conveyed to the remote location/s.

Embodiment c12. A system according to any of the preceding embodiments wherein the controller is operative to trigger at least one mobile communication device to convey data only when the processor has made a determination that data should be conveyed to the remote location/s.

Embodiment c13. A system according to any of the preceding embodiments wherein the controller is operative to scan the vehicle for mobile communication devices thereby to identify at least one mobile communication device temporarily within the vehicle's range and to trigger at least one mobile communication device thus identified to convey at least sonic of the data received from the at least one source to at least one remote destination, at least when an emergency situation is detected by the processor.

Embodiment c 14. A system according to any of the preceding embodiments wherein the at least one data-generating source includes at least one of

a sensor such as but not limited to camera or imager, microphone, accelereometer, odometer, thermostat, which may or may not be wearable and may or or may be an obd sensor,

an electronic component or logic generating output data such as but not limited to an electronic or software or firmware diagnostic component;

a tester e.g. BIT.

Embodiment c15. A system according to any of the preceding embodiments wherein the processor comprises an Emergency monitoring processor which receives data from at least one source including at least one vehicle-mounted source and repeatedly determines, based at least partly on at least some of the data, whether or not an emergency situation is present.

Embodiment c16. A system according to any of the preceding embodiments wherein the controller is operative, if an emergency situation is detected by the processor, to scan the vehicle for mobile communication devices thereby to identify at least one mobile communication device temporarily within the vehicle's range and to trigger at least one mobile communication device thus identified to distribute data regarding the emergency situation to at least one remote destination.

Embodiment c17. A system according to any of the preceding embodiments wherein the system is operative for automatically contacting at least one emergency center and wherein the processor is incorporated into call decision software which receives data from at least one vehicle-mounted source and determines, based at least partly on at least some of the data, whether or not an emergency situation is present and wherein the controller comprises an SCU which is operative, if an emergency situation is detected, to connect to the Driver's mobile and to send a signal, to an eCall mobile application residing on the driver's mobile which is connected to a cellular network, instructing the eCall mobile application to contact at last one designated emergency center, via the cellular network.

Embodiment c18. A method for conveying data generated on-board a vehicle, from the vehicle to at least one remote location/s, the system comprising:

Using an on-board data monitoring processor to receive data from at least one data-generating source including at least one vehicle-mounted data-generating source; and

at least on occasion, scanning the vehicle for mobile communication devices thereby to identify at least one mobile communication device temporarily within the vehicle's range and triggering at least one mobile communication device thus identified to convey at least some of the data received from the at least one source to at least one remote destination.

Embodiment c19. A computer program product, comprising a non-transitory tangible computer readable medium having computer readable program code embodied therein, the computer readable program code adapted to be executed to implement a method for conveying data generated on-board a vehicle, from the vehicle to at least one remote location/s, the system comprising:

Using an on-board data monitoring processor to receive data from at least one data-generating source including at least one vehicle-mounted data-generating source; and

at least on occasion, scanning the vehicle for mobile communication devices thereby to identify at least one mobile communication device temporarily within the vehicle's range and triggering at least one mobile communication device thus identified to convey at least some of the data received from the at least one source to at least one remote destination.

Embodiment c20. A system according to any of the preceding embodiments wherein the SCU establishes a link to all mobile devices found within range and the link remains open all the time irrespective of whether an emergency (or harbinger thereof, indicating higher-than-threshold risk of an imminent emergency) has occurred. Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer -usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display (e.g. on a computer screen or other computer output device), store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMS, ROMs, EPROMs, EEPROMs, magnetic or optical or other cards, for storing, and keyboard or mouse for accepting. Modules shown and described herein may include any one or combination or plurality of: a server, a data processor, a memory/computer storage, a. communication interface, a computer program stored in memory/computer storage.

The term “process” as used above is intended to include any type of computation or manipulation or transformation of data represented as physical, e.g. electronic, phenomena which may occur or reside e.g. within registers and /or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system./s, or processor/s or similar electronic computing device/s, that manipulate and/or transform data represented as physical, such as electronic, quantities within the computing system's registers author memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication. devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein e.g. by providing one or more modules in the processor/s to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1 is a simplified flowchart of a method for localizing a transmitting wireless device within a known volume, according to certain embodiments.

FIG. 2 illustrates example positions of antennae in a vehicle, within which a transmitting device is to be localized, in accordance with certain embodiments.

FIG. 3 illustrates a cellphone localization system provided in accordance with an embodiment of the present invention.

FIGS. 4 and 5 illustrate two respective locations A and B of the wireless device within a volume e.g. vehicle interior or room, in accordance with certain embodiments.

FIGS. 6a and 6b illustrate power levels (e.g. RSSI) of signals received at each of the antennae of FIGS. 4 and 5 respectively, e.g. for a specific wireless device which is relatively close to its serving base-station, in accordance with certain embodiments.

FIGS. 7a and 7b illustrate power levels of received signals in antennae for FIGS. 4 and 5, e.g. for a specific wireless device which is far (relative to FIGS. 6a. 6b) from the specific wireless devices' serving base-station, in accordance with certain embodiments.

FIGS. 8a-8b illustrate typical statistical variation of the power ratios ([650], [652], [750], of FIGS. 6a, 6b, 7a, 7b, in accordance with certain embodiments.

FIGS. 9a and 9b illustrate examples of real time activation of the locating method for two receiving antennae, in accordance with certain embodiments.

FIGS. 10a-10c are simplified flowchart illustrations of a cellphone localization process, in accordance with certain embodiments.

FIG. 11 is a simplified flowchart illustration of three calibration methods, any or all of which may for example be utilized in conjunction with the detailed localization process of FIGS. 10a-10c.

FIG. 12 is a simplified block diagram illustration of eCall system elements (of components of a system for generating emergency calls or for more generally transmitting data generating on-board a vehicle, to remote location/s; all or any subset of the following components may be provided, suitably coupled.

FIG. 13 is a system flow diagram of an example method for distributing data regarding an emergency situation which may for example be implemented in the logic of the SCU of FIG. 12; all or any subset of the illustrated operations may be provided, suitably ordered e.g. as shown. It is appreciated that since emergency situations can occur even if a vehicle is not in motion (e.g. even if the car has stopped because of a red light or due to malfunction on the side of a highway), the “Assure vehicle is moving” operation may be removed in sonic embodiments; instead the method may for example proceed directly from “Power on” to obtaining information from the OBD-ii and/or SCU.

FIGS. 14 and 16-20 are simplified semi-block diagram semi-pictorial illustrations useful in understanding certain embodiments of the present invention.

FIG. 15 is a simplified flowchart illustration of a method provided in accordance with certain embodiments of the present invention; all or any subset of the illustrated operations may be provided, suitably ordered e.g. as shown.

Methods and systems included in the scope of the present invention may include sonic (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or offline; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

A system for automatically providing data regarding vehicular emergencies that a vehicle undergoes is provided according to certain embodiments. Typically, the system comprises:

An emergency monitoring processor which receives data from at least one source including at least one vehicle-mounted source and repeatedly determines, based at least partly on at least some of the data, whether or not an emergency situation is present; and/or

a controller which is operative, if an emergency situation is detected by the processor, to scan the vehicle for mobile communication devices thereby to identify at least one mobile communication device e.g. a mobile communication device temporarily within the vehicle's range e.g. temporarily present in the vehicle as opposed to a modem installed in the vehicle, and to trigger at least one mobile communication device thus identified to distribute data regarding the emergency situation to at least one remote destination.

Alternatively however, the processor and/or controller may be used to convey data generated or derived on-board the vehicle other than emergency data e.g., say, vehicle maintenance data, or medical data pertaining to passengers. Therefore, all embodiments described herein which are described with reference to emergencies, ecall etc. may also be employed to convey data generated or derived on-board the vehicle other than emergency data.

The Emergency monitoring processor may be integrated with the eCall decision software (which may alternatively be partly or entirely implemented in hardware or firmware) as described herein.

The controller may be integrated with the SCU as described herein and/or with the eCall decision software (which may alternatively be partly or entirely implemented in hardware or firmware) as described herein and/or with the eCall mobile application as described herein). The controller may operate in accordance with any of the embodiments described herein e.g. with reference to FIG. 13, 15 or 17-20.

More generally, the processor may for example be deployed either as part of the SCU or as part of the mobile device, and the controller, too, may for example be deployed either as part of the SCU or as part of the mobile device.

According to certain embodiments, the mobile communication device/s temporarily within the vehicle's range e.g. temporarily present in the vehicle are identified after having first been paired to the vehicle Bluetooth.

According to certain embodiments, the mobile communication device/s are identified by BLE (BlueTooth Low Energy) and pairing is not needed.

According to certain embodiments, the mobile communication device/s temporarily within the vehicle's range e.g. temporarily present in the vehicle are identified after having first downloading a cell app which provides the devices with functionality allowing the devices to interact with the controller including placing their modem at the disposal of the controller for transmitting emergency data to remote location/s as commanded by the controller.

The cell application may include all or any subset of the following modules:
i. Interface to the SCU.
ii. Interface to server.
iii. Interface to one or more remote Emergency centers.
iv. Login mechanism in order to know who is the driver.
v. Log mechanism that includes driver behavior (e g. which applications the driver tries to use while driving, start driving time/s etc.).
vi. User Interface that enables the driver to configure/calibrate the system.

The interface I between the SCU and the cellular application may have a connected mode and a multicast/broad cast mode. In addition, the SCU may update the cellular application as to whether the app's position is in the driver seat or in a passenger seat (e.g. so that, if in the driver seat, the cellular application may block applications that are impermissible while driving). In addition this interface typically allows the SCU to send its log data to the cellular application and/or allows SCU firmware to be updated via this interface and/or this interface allows the SCU to update the cellular application when an emergency situation was occurred or otherwise convey on-board generated data which may be earmarked for transmittal to designated remote locations.

The Interface ii may be used to allow the cellular application to get a list of applications permitted (or not permitted) to use while driving and/or firmware to be downloaded to the SCU. The cellular application may send the server any or all of the following: all the events (start driving, stop driving, block application SCU log, cellular application log, SCU versions etc.

Via Interface III to one or more remote Emergency centers, the SCU may send data to remote locations e.g. emergency center/s, such as some or all of: vehicle license plate number, make/model, accident time, location and driver phone number.

Typically, the server includes a user interface aka UI that may for example enable an end user (e.g. a “manager” end-user) to determine which cellular applications have “allowed to use during driving” status and/or to update or otherwise determine the firmware versions for the SCU, information regarding the drivers and their cellphones may be saved in the server's DB (database).

The emergency monitoring processor may determine whether or not an emergency situation is present on occasion e.g. periodically where the period may be fixed (say on the order of 1 second, or more, or less) or may depend on risk factors such as but not limited to high velocity, high acceleration/deceleration, “red road” (accident-prone) location, known driver characteristics e.g. young age, known vehicle characteristics e.g. truck vs. car, long journey duration, late-night journey vs. daytime journey.

This embodiment is advantageous inter alia because there is no need to install a modem in the vehicle and instead, mobile communication device/s temporarily within the vehicle's range e.g. temporarily present in the vehicle (not permanently installed therewithin) are utilized to send emergency notifications to remote location/s.

FIG. 12 illustrates a system aka the eCall system; all or any subset of the illustrated components may be provided, suitably coupled e.g. as illustrated. It is appreciated that the term ecall used herein refers to an example embodiment including any system for alerting remote destinations regarding an emergency on board a moving substrate e.g. vehicle; as well as, more generally, to embodiments in which data generated on board a moving substrate is transmitted to one or more remote destinations.

FIG. 13 is a System flow diagram: all or any subset of the illustrated operations may be provided, suitably ordered e.g. as shown. The operations of FIG. 13 may be performed standalone or may be performed by the system of FIG. 12.

The message to the emergency center may be sent repeatedly until acknowledgement is received from the emergency center. The system may try to initiate the call with the emergency center repeatedly until call initiation succeeds.

The system elements may include any or all of:
Vehicle OBD-II interface or similar interface (101). Generally, references to OBD-II herein are merely exemplary and may more generally be regarded as including any interface/s to any data-generating source/s aboard a vehicle such as vehicle diagnostics and/or sensors.
Vehicle safety sensors: front/side collision, rollover, safety belt, air bags, lane shifting, collision warning' ESP (Electronic Stability System) (102)
Other vehicle parameters (obtained through the OBD-II or similar): speed, direction, location (103)
SaverOne system of FIG. 13 may include any or all of:
SaverOne System Control Unit (SCU) (201)
eCall decision software (202) (or more generally, an emergency monitoring processor or a processor monitoring data generating on-board a vehicle which may or may not be emergency-related);
SaverOne system's sensors (203)
SaverOne mobile application (301)
eCall mobile application (302) intended to include any cell app which allows a mobile temporarily within the vehicle's range e.g. temporarily on board a vehicle to interact with a controller tasked with using mobile communication devices temporarily within the vehicle's range e.g. temporarily on board a vehicle for transmitting on-board generated data to remote destinations. System operation:
The eCall decision software (202) (or more generally, an emergency monitoring processor) receives data from various sources which may include any or all of:
Vehicle OBD-II interface or similar interface (101): data may include any or all of speed, acceleration, direction, location, front/side collision, rollover, safety belt, air bags, lane shifting, collision warning ESP (Electronic Stability System)
SaverOne SCU (201): data may include any or all of location, acceleration, speed

The eCall decision software (202) (which may, if desired be alternatively be implemented partly or entirely in hardware or firmware) runs any predetermined decision algorithm and determines if an emergency situation is present. If an emergency situation is present, the SCU (201) connects to the Driver's mobile or any other mobile in the vehicle equipped with the SaverOne application via wireless communication such as BlueTooth, BLE or Wi-Fi (indeed it is appreciated that references herein to Bluetooth may instead employ other wireless communication protocols and technologies) and instructs the SaverOne's eCall mobile application (302) to initiate a call to the designated emergency center. This may allow the emergency center personnel to talk with the driver or a passenger even if he/she cannot reach the phone. In addition, various parameters may be sent to the emergency center such as but not limited to one some or all of: location, air bags status, vehicle make & model, vehicle license plate number, and other parameters such as, say, last speed of the vehicle, acceleration (to assist with evaluating event severity).

An emergency situation is intended to include any situation which requires rapid intervention. A need for emergency medical care is one example of such a situation. The need to promptly document a traffic accident's outcome is another example of such a situation.

Receiving parameters from both the OBD-II (101) and from SaverOne SCU (201) creates redundancy and increases the reliability of data to the eCall decision software (202) (or more generally, emergency monitoring processor).

The SCU (201) may use the SaverOne mobile application (301) and the sensors (203) to ensure that the driver's cellphone/passenger's phone has connection with the SCU (201) and to ensure that the SaverOne's eCall mobile application (302) is running in the driver's mobile phone/passenger's phone. The functionality offered by this system ensures this, and verifies that in an emergency situation the required call and transfer of required parameters may be carried out.

By knowing the vehicle's location, the suitable emergency center can be called, e.g. an emergency medical care facility, creating efficient operation and increasing chances for effective rescue, during the “golden hour”.

Use of the term “SaverOne” herein indicates that the component in question may for example be as described in the following co-pending application: System and Methods to Facilitate Safe Driving—PCT/IL2015/050630 filed Jun. 22, 2015 and published as WO 2015/198306 on Dec. 30, 2015,

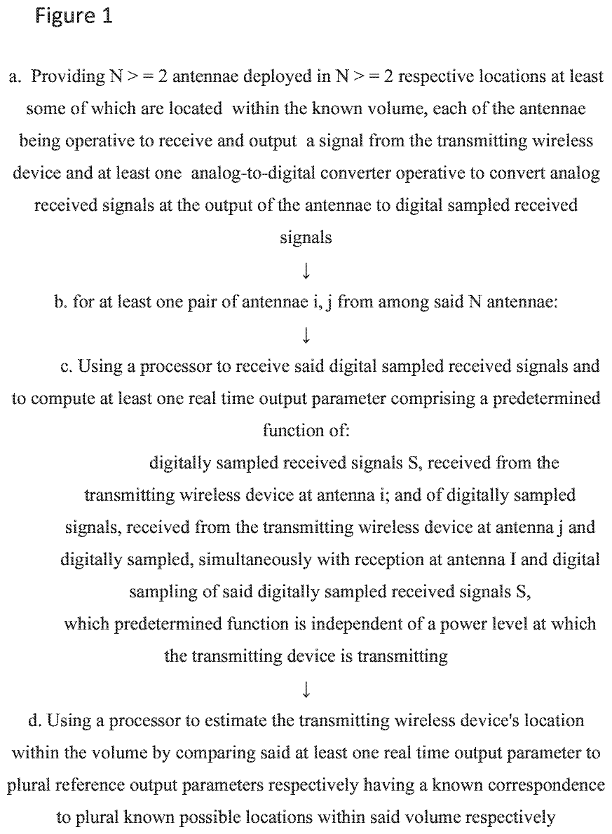

and/or as described with reference to FIGS. 1-11 herein and/or with reference to other embodiments herein.

For example, terms like SaverOne System Control Unit (SCU) or “SCU” may comprise any control unit embodiment shown and described in either of the above patent documents; terms like SaverOne system's sensors may refer to any sensor shown and described in either of the above patent documents; terms like SaverOne mobile application may include any of the cell app functionalities shown and described in either of the above patent documents.

PCT/IL2015/050630 describes inter aha that a mobile application may start upon mobile power on and run in the background when the phone is not located inside the vehicle, waiting to detect the connection to a system control unit. The CPU knows that driver disconnected the BT (BlueTooth) e.g: “Mobile App connected or Disconnected”. Typically, whenever the CPU gets no response from the mobile app—If there was a BT (BlueTooth) connection, then the BT (BlueTooth) controller in the communication module knows there was a disconnection, and may notify the system control unit. If there was no previous connection since the engine was started there is typically a T.O. (time out) interrupt that may be activated if-and-only-if the Cell ID module has detected a mobile device in the driver's vicinity. In this case the system would typically know that the BT (BlueTooth) is disconnected and/or the mobile app has been removed from the driver's phone—either way this is a “disconnection” which justifies entry into alarm mode. DSP may determine if there is a cellphone in the driver's area, and notifies the CPU. While no cellphone has been found, the check continues (e.g. until a predetermined time-out has elapsed). Once a cellphone has been found, the CPU checks if a wireless e.g. BlueTooth connection has been established. In an Alert mode, the vehicle is driving and no connection is detected between the Mobile application and the system control unit, while Cellphone Identification module unit identifies Cellular phone in the driver's seat area This functionality may be used in conjunction with the embodiments shown and described herein, e.g. in order to detect that a mobile communication device has entered the vehicle. For example, if the entering device is found not to have a cell app as shown and described herein installed, the bearer of the entering device may be prompted to download the app e.g. by a recurrent audio signal.

Solution implementations include but are not limited to:
1. Aftermarkets existing vehicles that will install SaverOne system and may receive the SaverOne eCall solution.
2. Automotive industry solution for the auto makers: a solution that can reduce the need for a dedicated SIM in the vehicle, avoiding operating costs and additional contractual agreements.

The eCall solution's advantages e.g. over a solution that uses Mobile Gravity/acceleration/GPS sensor may include any or all of the following:
1. Use vehicle indicators that are 100% reliable and are ‘approved’ by the automotive industry vs. mobile G sensors that might not be reliable
2. Contrary to other such systems, SaverOne system verifies that the mobile app exists and is running in the mobile phone (otherwise an alarm signal is sent, leading to the driver activating the mobile app).
3. Another solution has a 30 sec timer that can be critical for the injured person.
4. This app can be activated automatically when it is in the driver's phone and when he is driving. Other eCall solutions that are application-based should be activated manually, or may be activated for the passengers as well.

The advantages e.g. over a solution that uses In-vehicle SIM may include any or all of the following:
1. No need for a dedicated cellular modem in the vehicle—operating costs e.g. subscription to a service provider and additional contractual agreements are avoided
2. The solution can be implemented for an aftermarket as well, not just for new cars
3. The end-user gets this benefit ‘free of charge’ whenever he installs SaverOne's system in his car
4. identification and use of the Driver Phone's Identification number (ID)
5. Efficient provision of any or all of the set of functionalities described in co-pending patent application PCT/IL2015/050630, in combination with any or all of the set of functionalities described herein, due to double utilization (by functionalities from both sets) of certain system capabilities such as but not limited to (a) localization of cellphones within the vehicle including logical deductions such as whether or not a cellphone belongs to the vehicle's driver, and/or (b) cell app registering and/or obtaining consent from end-users and/or (c) use of logs from statistics database.

Certain embodiments of the present invention employ a system and methods to locate a wireless device in a volume, e.g. a room or (as in the illustrated embodiments) an interior of a vehicle.

The environment inside a vehicle is often characterized by reflections from metal, glass, plastics and other dielectric materials.

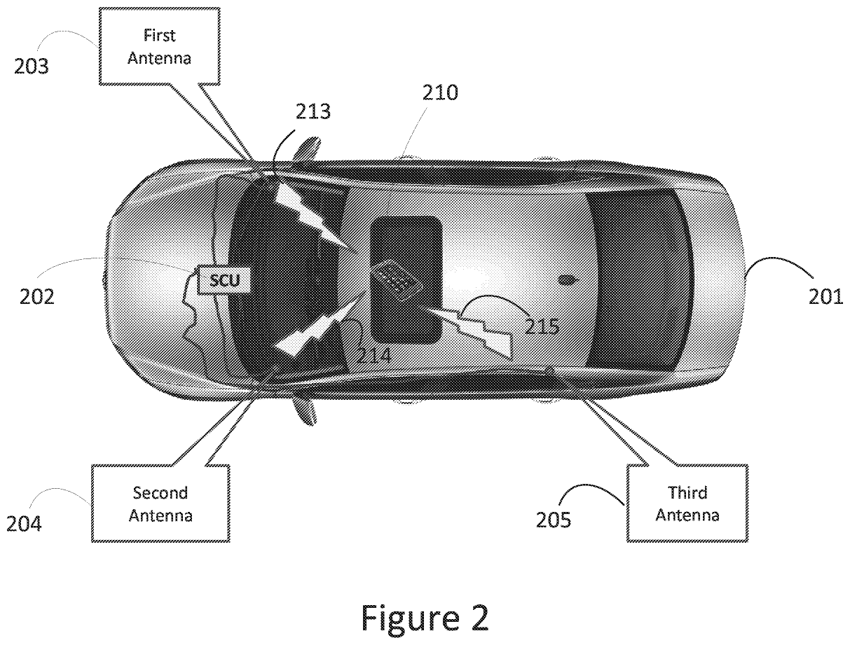

FIG. 1 is a simplified flowchart of a method for localizing a transmitting wireless device within a known volume, according to certain embodiments. The flow of FIG. 1 may be suitably combined with some or all of the elements illustrated in any of the drawings from FIG. 2 onwards.

Regarding the method of FIG. 1, localization (estimating location) may for example include determining whether or not the transmitting device is within a specific location inside the volume, such as the device's cradle, if the cradle is fixedly deployed within the known volume.

Each of the antennae may be operative to receive at least one analog signal from the transmitting wireless device which may be converted, by at least one analog-to-digital converter, to digital sampled received signals.

According to certain embodiments, a system for localizing a radiating device within a known volume is provided, the system comprising: N>=2 antennae deployed in N>=2 respective locations of which at least some are within the known volume, each of the antennae being operative to output its quality of reception of signals radiation from the radiating device; and a processor operative to receive the quality of reception from the antennae and to compute at least one real time output comprising a predetermined function of:

quality of reception of radiation from the radiating device at antenna i; and of

simultaneous quality of reception of radiation from the radiating device at antenna. j,

for at least one pair of antennae i, j from among the N antennae, whose predetermined function is independent of a power level at which the radiating device is radiating, and to estimate the radiating device's location within the volume by comparing the at least one real time output to plural reference outputs respectively having a known correspondence to plural known possible locations within the volume respectively.

According to certain embodiments, a system for localizing a radiating device within a volume is provided, the system comprising:

N>=2 antennae deployed in N>=2 respective locations of which some or all are within the known volume, each of the antennae being operative to output its received signal from the radiating/transmitting wireless device; and analog-to-digital converter's operative to convert the analog received signals at the output of the antennae to digital sampled received signals, and a processor operative to receive the digital sampled received signals and to compute at least one real time output parameter comprising a predetermined function of:
digital sampled received signals from the radiating/transmitting wireless device at antenna i; and of simultaneous digital sampled received signals from the radiating/transmitting wireless device at antenna j, whose predetermined function is independent of a power level at which the radiating/transmitting device is radiating/transmitting, and to estimate the radiating/transmitting wireless device's location within the volume by comparing the at least one real time output parameter to plural reference outputs parameters respectively having a known correspondence to plural known possible locations within the volume respectively, for at least one pair of antennae i, j from among the N antennae.

It is appreciated that true simultaneity is a theoretical concept, hence, practically speaking, an insignificant time interval, say of 10 or 20 or a few dozen millisec, may unavoidably elapse between digital sampling of signals, received from the transmitting wireless device at antenna j and digitally sampled, on the one hand, and reception at antenna i and digital sampling of the digitally sampled received signals S, on the other hand; this has little adverse practical significance, however, e.g. since the extent of motion of the cellular device over such a short time period is negligible relative to other relevant quantities in the total situation. Also, PDFs may be integrated over much longer time periods e.g. over hundreds of milliseconds or seconds.

It is appreciated that true simultaneity is a theoretical concept, hence, practically speaking, an insignificant time interval, say of nanoseconds, microseconds or even 10 or 20 or a few dozen millisec, may unavoidably elapse between digital sampling of signals, received from the transmitting wireless device at antenna j and digitally sampled, on the one hand, and reception at antenna i and digital sampling of the digitally sampled received signals S, on the other hand. This typically has little adverse practical significance, however, e.g. since the extent of motion of the cellular device by the user over such a short time period is negligible relative to other relevant quantities in the total situation. Also, PDFs may be integrated over much longer time periods e.g. over hundreds of milliseconds or seconds.

FIG. 2 is a pictorial illustration of an example location system configuration. It is sought to determine a location within a vehicle 201, of wireless device [210] (e.g. cellular phone/smartphone, tablet, modem, etc.) that uses a communication protocol (e.g. cellular 2G/3G/4G/5G, WiMAX, Wi-Fi, Bluetooth, Near-Field-Communication). A system control unit (SCU) [202] is connected to plural antennae e.g. [203] [204] [205]. Each of the antennae receive a signal [213] [214] [215] respectively, transmitted from wireless device [210].

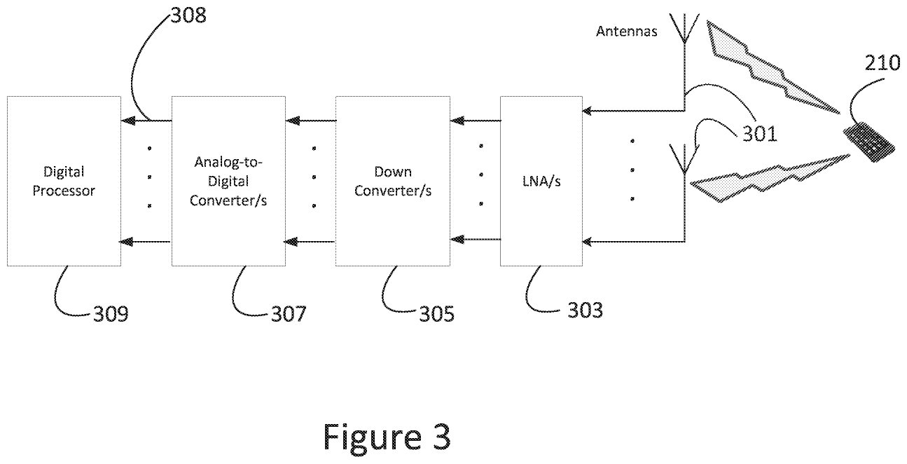

FIG. 3 illustrates a cellphone localization system provided in accordance with an embodiment of the present invention. Generally, main antenna/e and reference antenna/e may be employed the receiving RF signals from a wireless device. Low Noise Amplifiers may be provided to amplify weak RF signals without adding too much noise. An AID (Analog to Digital converter) may be provided to convert the analog RF signal collected by the antennae into digital data for analysis by a DSP (Digital Signal Processing) chip that is used to analyze the RF signals. The DSP is configured to find the position of the wireless device in the vehicle; e.g. using any suitable localization algorithm. It is appreciated that each illustrated element may in fact comprise plural such elements.

The Antennae [301] are typically first to receive signals transmitted from the wireless device [210]. If Low-Noise Amplifier/s (LNA) [303] are provided, these amplify the received signal with the addition of minimal noise. If a Down-Converters Layer [305] is provided, it converts the RF signal to IF (Intermediate Frequency) or to a base-band signal. ADCs (Analog-to-Digital Converter/s) [307] are operative to convert the analog signal to digital samples. Digital signals [308] originally received by each particular antenna, may then be processed by the Digital Processor [309].

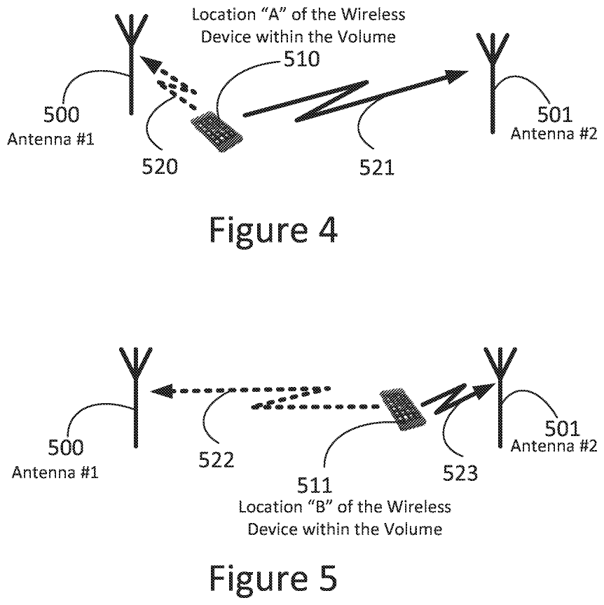

In FIGS. 4 and 5, two respective locations “A” and “B” of the wireless device within a volume e.g. vehicle interior or room, are shown. Two reception antennae #1 [500] and #2 [501] are shown by way of example although more than two such antennae may be provided.

In FIG. 4 the wireless device [510] is at location “A” which is closer to Antenna #1 [500] than to Antenna 2. Each of the antennae receives the transmitted signal. Antenna #1 [500] receives signal [520] traveling through the wireless channel between wireless device [510] and Antenna #1 [500]. Antenna #2 [501] receives signal [521] traveling through the wireless channel between wireless device [510] and Antenna #1 [500].

In FIG. 5 the wireless device [511] is located in location “B” which is closer to Antenna #2 [501] than to Antenna 1. Here too each of the antennae receives the transmitted signal. Antenna #1 [500] receives signal [522] traveling through the wireless channel between the wireless device [511] and Antenna #1 [500]. and Antenna #2 [501] receive the signal [523] traveling through the wireless channel between wireless device [511] and Antenna #1 [500].

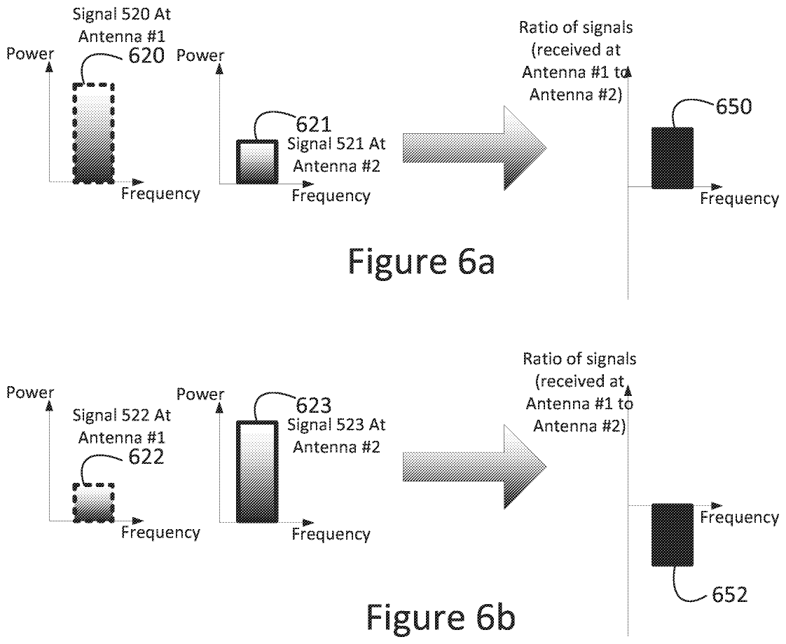

In FIGS. 6a and 6b power levels (e.g. RSS/RSSI) of signals received at each of the antennae are shown for FIGS. 4 and 5 respectively, for a specific wireless device that transmits relatively low power which is e.g. relatively close to its serving base-station (or e.g. to another wireless device which needs to receive the specific wireless device's transmission or e.g. for a relative low data rate of transmission that needs to be sent to the receiver of the transmitting wireless device from the wireless device.

In FIG. 6a the power of received signal [520] in FIG. 4 is [620] whereas the power of received signal [521] in FIG. 4 is [621]. Because mobile device [510] in FIG. 4 is closer to antenna #1 than to antenna 2, the power [620] received at antenna #1 is higher than the power received in antenna.#2. So Ratio [650] in linear scale (which is minus in decibels) between the power received in antenna #1 [620] and the power received in antenna #2 [621] is positive because the nominator [620] is bigger than the denominator [621] i.e. the power received in antenna #1 [620] is larger than (exceeds) the power received in antenna #2 [621]. The ratio may be assumed to be e.g. an average of values varying over time and/or frequency.

In FIG. 6b the power of received signal [522] in FIG. 5 is [622], whereas the power of received signal [523] in FIG. 5 is [623]. Since the mobile device [511] in FIG. 5 is closer to antenna #2 than to antenna 1, the power [622] received in antenna#1 is lower than the power received in antenna 2, Ratio [652] (minus in decibels) between the power [622] received in antenna #1 and the power [623] received in antenna #2, is negative because the nominator is smaller than the denominator [621] i.e. the power [622] received in antenna #1 is less than the power received in antenna #2.

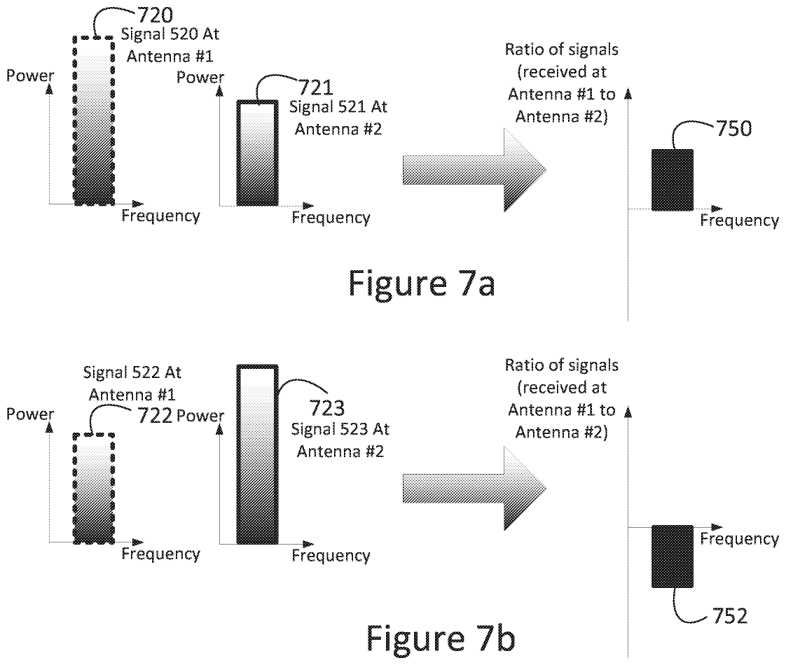

In FIGS. 7a and 7b the power levels (e.g. RSS/RSSI) of the received signals in each of the antennae are again shown for FIGS. 4 and 5, this time for a specific wireless device that transmits relatively high power which is e.g. far (relative to FIGS. 6a, 6b) from the specific wireless device's serving base-station (or e.g, from another wireless device which needs to receive the specific wireless device's transmission) or e.g. for a relatively high data rate of transmission that needs to be sent to the receiver of the transmitting wireless device from the wireless device. A power control mechanism may be enabled for the wireless system (or wireless protocol) of the wireless device, and hence, in FIGS. 7a and 7b, the wireless device may transmit using a higher output power relative to the wireless device in FIGS. 6a, 6b. Similarly, in FIGS. 6a and 6b, the wireless device may transmit using a lower output power relative to the wireless device in FIGS. 7a. 7b.

In FIG. 7a the power of received signal [520] of FIG. 4 is [720], whereas the power of received signal [521] in FIG. 4 is [721]. Because the mobile device [510] in FIG. 4 is closer to antenna #1 than to antenna 2, the power [720] received at antenna #1 is higher than the power received at antenna #2 [721], Ratio [750] (minus in decibels) between the power [720] received at antenna #1 and the power [721] received at antenna #2 is positive because the nominator [720] is bigger than the denominator [721].

In FIG. 7b the power of received signal [522] in FIG. 5 is [722], whereas the power of received signal [523] in FIG. 5 is [723]. Because mobile device [511] in FIG. 5 is closer to antenna #2 than to antenna 1, the power [722] received in antenna #1 is lower than the power received in antenna#2. Ratio [752] (minus in decibels) between the power [722] received in antenna #1 and the power [723] received in antenna #2 is negative because the nominator is smaller than the denominator [721].

It is appreciated that the magnitude of the ratio [650] in FIG. 6a is similar to the magnitude of the ratio [750] of FIG. 7a. More generally, even though the wireless device transmits at different power levels e.g. in view of its varying distance from the base-station (or from its receiving wireless device) or may transmit different data-rates; nonetheless the magnitude of the ratio remains similar, yielding robust location capability of the wireless device irrespective of the current transmitted power level (that is for example related the geographical location of the wireless device with respect to its serving base-station or its receiving wireless device, or its data-rate). Similarly, the magnitude of the ratio [652] in FIG. 6b is similar to the magnitude of the ratio [752] of FIG. 7b, although the specific wireless device transmits at different power levels, as the specific device's distance from the base-station (or its receiving wireless device) varies, or the specific device may transmit at different data-rates. The distance between the ratio parameters for locations “A” and location “B” is large and in this example using the sign (positive or negative) of the power ratio may provide an indication of the location of the wireless device between/relative to (e.g. known) locations “A” and “B”.

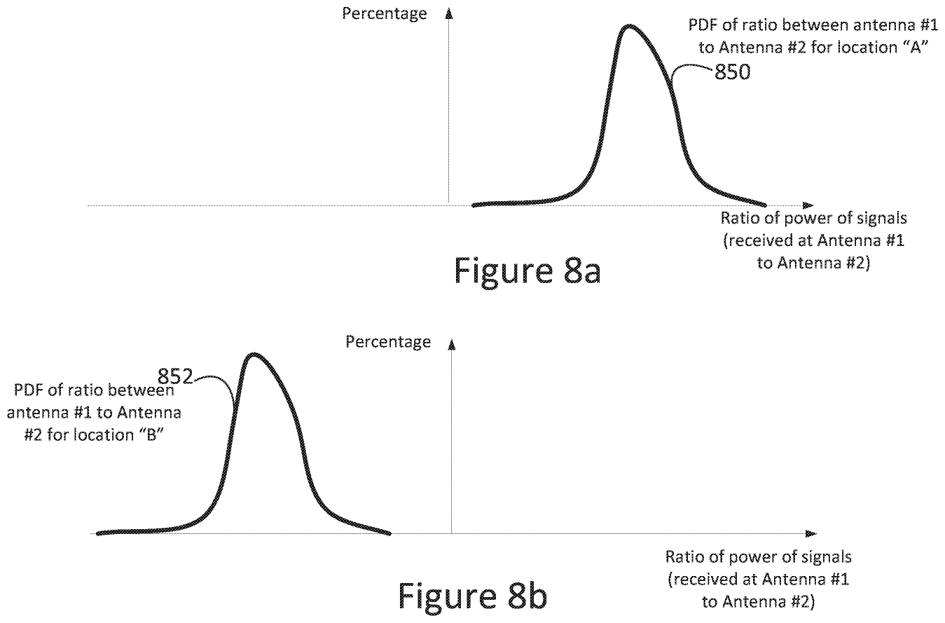

FIGS. 8a-8b illustrate typical statistical variation of the power ratios ([650], [652], [750], of FIGS. 6a, 6b, 7a, 7b. To overcome wireless effects that may degrade the ability to correctly determine the location of the wireless device based on the power ratio between the antennae, a vector of power ratios collected during a typical period of time (e.g. dozens or hundreds of milliseconds or even several seconds or more) may be stored. Thereafter, from the stored vector of power ratios a PDF (Probability Density Function) of these ratios (i.e. treating the ratio as a variable) may be computed. In FIG. 8a the PDF for a wireless device close to Antenna #1 is shown, The PDF graph [850] represents a distribution of power ratios [650] or [750] of FIG. 6a or 7a respectively. In FIG. 8b, the PDF graph [852] represents a distribution of power ratios [652] or [752] of FIG. 6b or 7b respectively.

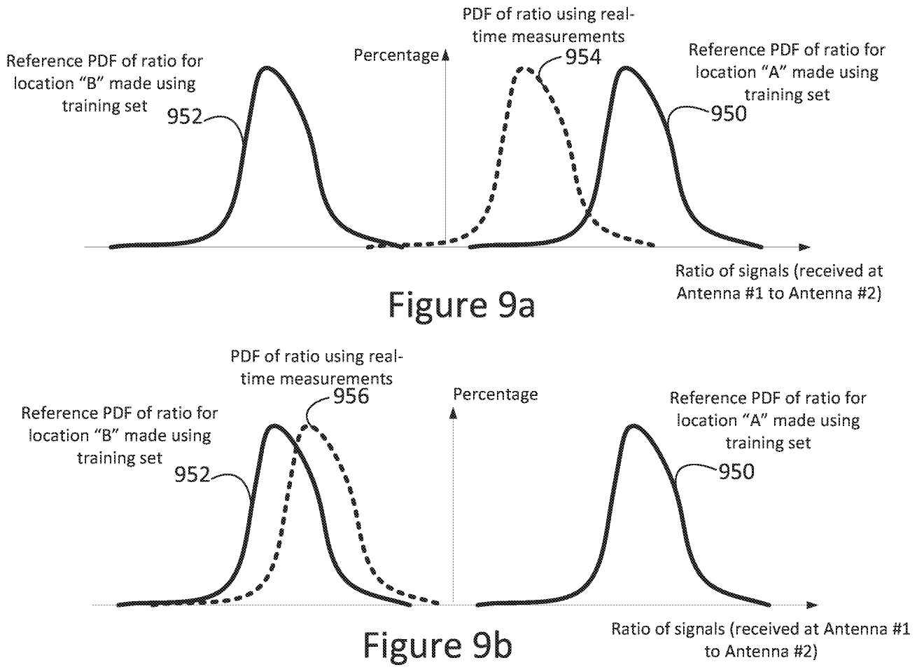

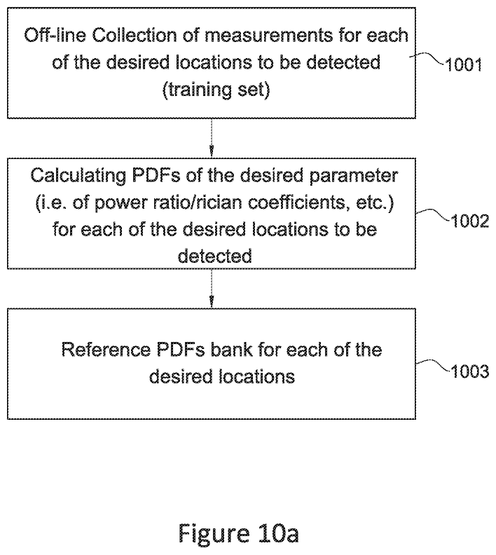

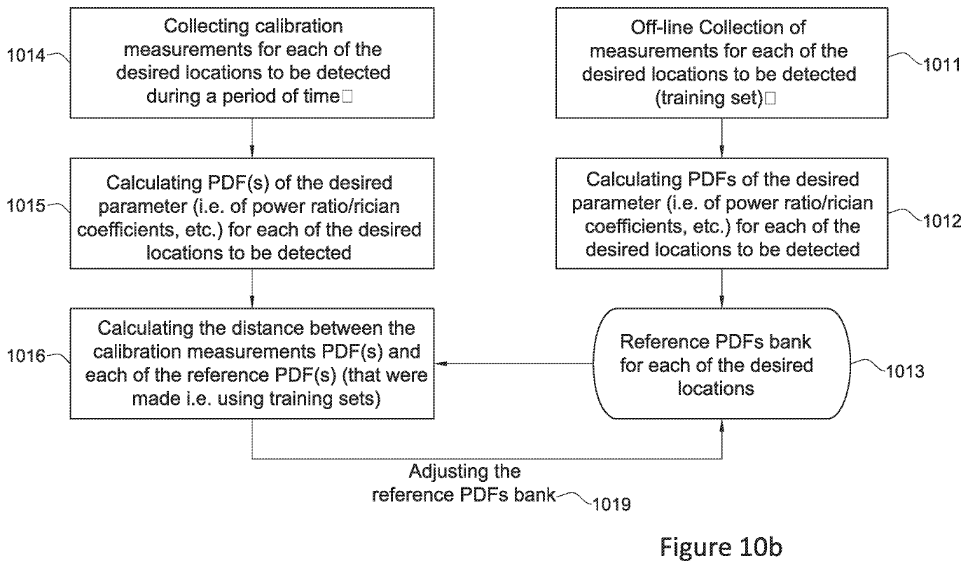

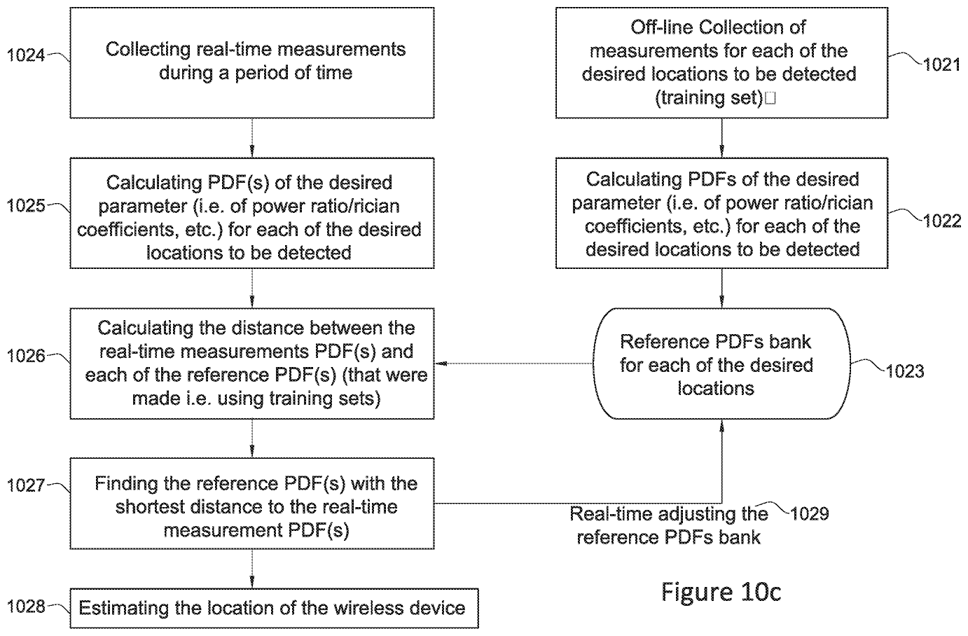

FIGS. 9a and 9b illustrate examples of real time activation of the locating method for two receiving antennae e.g the antennae of FIGS. 4 and 5 e.g. using the method of FIG. 10c described in detail below. In FIGS. 9a and 9b, reference PDFs [950] and [952] correspond to locations “A” and “B” respectively. These reference PDFs may be generated e.g. as described in FIG. 10a, operations [1001] and [1002] and may be stored in a reference PDFs bank [1003] (and similarly in reference PDFs banks [1013] and [1023] in FIGS. 10b and 10c respectively). Real-time PDFs [954] in FIG. 9a and [956] in FIG. 9b may be generated e.g. by operation [1025] in FIG. 10c. FIG. 9a shows that the real-time PDF is closer to reference PDF [950] than to reference PDF [952] and therefore the decision may be that the wireless device is in location “A”. Conversely, in FIG. 9b the real-time PDF is closer to reference PDF [952] than to reference PDF [950] hence the decision may be that the wireless device is in location “B”.

A wireless device (e.g. cellphone) localization process is now described with reference to FIGS. 10a-10c, The localization process includes some or all of, in any suitable order e.g. as shown:

creating a reference PDFs bank e.g. as shown in FIG. 10a,

initial calibration in a new volume type e.g. as shown in FIG. 10b, and

real-time localization of the wireless device/cellphone e.g. as shown in FIG. 10c.

Turning now to FIG. 10a, the reference PDF bank generation process typically includes some or all of the following operations, suitably ordered e.g. as shown:

Operation 1001: Off-line collection of measurements (samples) when the transmitting/radiating device e.g. smartphone is positioned in each of several locations within a volume (training set)

Operation 1002: determine desired parameter/quality of reception/RSSI, compute PDFs of the desired parameter (e.g. power ratio/Rician coefficients, etc) for each of the locations or each of several pairs of locations

Operation 1003: store as Reference PDFs—one per each of the locations

The calibration within new volume process of FIG. 10b typically includes some or all of the following operations, suitably ordered e.g. as shown:

Operation 1011: Off-line collection of measurements for each of the desired locations to be detected (training set). This operation may be similar to operation 1001 of FIG. 10a.

Example; a set of example locations at which a transmitting/radiating device such as smartphone may be positioned, when training a system according to certain embodiments of the present invention, may include locations in which the driver's cellphone is likely to be deployed (e.g. when held by the driver), and/or locations in which the passenger's cellphone is likely to be deployed (e.g. when held by the passenger), for example, respectively, some or all of the following:
Some or all of the following six habitual locations in the driver's area or vicinity or quadrant:
1—on the dashboard
2—held by the driver, in front of the chest
3—held by the driver, close to his right knee
4—held by the driver, left of the steering wheel
5—held by the driver, above the steering wheel
6—held by the driver, on the middle of the steering wheel.

It is appreciated that “quadrant” is used herein not to refer to region occupying exactly 25% of the vehicle interior, but instead to include or consist of a region within the total vehicular interior including the driver's seat and the portion of the interior in front of the driver's seat; similarly a passenger's quadrant may include or consist of a region within the total vehicular interior including the passenger's seat and the portion of the interior in front of her or his seat.
Some or all of the following six habitual locations in the front seat passenger's area or quadrant:
1—held by the passenger, close to his right ear
2—held by the passenger, in front of the chest
3—held by the passenger, close to his left ear
4—held by the passenger, close to his right knee
5—on the dashboard in front of the passenger
6—held by the passenger, close to his left knee

Operation 1012: Computing PDFs of the desired parameter (i.e. of power ratio/Rician coefficients, etc.) for each of the desired locations to be detected (this operation may be similar to operation 1002 of FIG. 10a.) and store in Reference PDFs bank 1013 for each of the desired locations.

Operation 1014: Collecting calibration measurements for each of the desired locations to be detected during a period of time e.g. a period of some seconds or minutes.

Operation 1015: Computing PDF or PDFs of the desired parameter (e.g. of power ratio/Rician coefficients, etc.) for each of the desired locations to be detected.

Operation 1016: using the data stored in operation 1012, compute the distance between the calibration measurements PDF(s) and each of the reference PDF(s) generated using training sets).

Operation 1019: using the distance (or distances) computed at operation 1016, adjusting the PDF(s) of the Reference PDFs bank 1013. An example of such adjustment can be e.g. by replacing the PI)F in the Reference PDF bank closest to the PI)F computed in operation 1015, with the PDF computed in operation 1015. Another example of adjustment may include replacing the PDF of the Reference PDF bank less than fully e.g. replacing the PDF stored in the
Reference PDF bank with a linear or other combination of:

the closest PDF from the reference bank; and

the PDF computed in operation 1015.

The real-time localization process of FIG. 10c typically includes some or all of the following operations, suitably ordered e.g. as shown:

Operation 1021: Off-line collection of measurements for each of the desired locations to be detected (training set) e.g. similar to operation 1001 of FIG. 10a

Operation 1022: Computing PDFs of the desired parameter (i.e. of power ratio/Rician coefficients, etc.) for each of the desired locations to be detected e.g. similar to operation 1002 of FIG. 10a and storing in Reference PDFs bank 1023 for each of the desired locations.

Operation 1024: Collecting real-time measurements during a period of time

Operation 1025: Computing PDFs of the desired parameter of power ratio/Rician coefficients, etc.) for each of the desired locations to be detected

Operation 1026: Computing the distance between the real-time measurements PDF(s) and each of the reference PDF(s) (that were made i.e. using training sets)

Operation 1027: Finding the reference PDF(s) with the shortest distance to the real-time measurement PDF(s) and real-time adjusting the reference PDF bank 1023

Operation 1028: use the result of operation 1027 for estimating the location of the wireless device e.g. by determining the current location as the location whose PDF is closest to the real-time PDF

Operation 1039: using the distance (or distances) computed at operation 1026 or the reference PDF with the shortest distance to the real-time measurement PDF(s) at operation 1027, adjusting, in real-time, the PDF(s) of the Reference PDFs bank 1023. Adjustment may for example include replacing the PDF in the Reference PDFs bank closest to the real-time PDF of operation 1025 with the real-time PDF of operation 1015. Furthermore, rather than fully replacing the PDF of the Reference PDFs bank, adjustment may include replacing the PDF of the Reference PDFs bank with a combination e.g. linear) of the closest PDF from the reference bank and the real-time PDF of operation 1025.
It is appreciated that distance computations between PDFs may be made according to various criteria, such as but not limited to:
Data Hard—conventional (“basic”) algorithm with hard decision—aka MLHD
PDF L2—measuring distances between PDF's by a second norm described herein, Norm 2—aka 1:2 or 1:2 criterion
PDF L1—measuring distances between PDF's by a first norm described herein, Norm 1—aka L1 or “L1” criterion
Smirnoff—measuring the maximal distances between CDF's.
PDF Weighted—weighted distances between PDF's—aka “weighted. L2”
PDF Correlation—measuring correlation between PDF's—aka “correlative”
Data Soft—conventional (“basic”) algorithm with soft decision—aka MLSD
Rank—PDF's of 24 combinations when sorting the 4 antennae by power e.g. as described herein.

Definitions:

x={x(tᵢ)}—is a four-dimensional vector of the normalized samples of sensors (e.g. antenna/e) power obtained during “training” stage for the case of a cell phone in the driver's area.

fₓ(x)—is a four-dimensional PDF histogram with cumulative histogram Fₓ(x).

y={y(tᵢ)}—is a four-dimensional vector of the normalized samples of sensors (e.g. antenna/e) power obtained during the “training” stage in the case of a cell phone in the passenger's area.

f_{y}(y)—is a four-dimensional PDF histogram with cumulative histogram F_{y}(y).

m ={m(tᵢ)}—is a four-dimensional vector of the normalized samples of sensors e.g. antenna/e) power obtained during real-time measurements.

\tilde{f}ₘ(m)—is a four-dimensional histogram with cumulative histogram Fₘ(m). Suppose that length of the vector m is significantly less than length of training vectors x and y, so \tilde{f}ₘ(m) is less exact then and fₓ(x) and f_{y}(y). In [3] influence of the length of vector m was considered as the most important parameter of different SCU algorithms quality.

Given: x={x(tᵢ)}, y={y(tᵢ)}, m={m(tᵢ)}.

SCU [202] in FIG. 2 is configured to determine whether the distance (which is to be defined) between \tilde{f}ₘ(m) and fₓ(x) (or between \tilde{F}ₘ(m) and Fₓ(x)) exceeds (or does not exceed) the distance between \tilde{f}ₘ(m) and f_{y}(y) (or between) \tilde{F}ₘ(m), F_{y}(y)). Each of the above criteria's sensitivity to length of vector m={m(tᵢ)} may be estimated, as may be their sensitivity to resolution of observations' quantization,

Two kinds of errors are considered: False Alarm (FA) and Missed Signal (MS). Deem a process to be convergent if the error probabilities Pr(FA)=Pr(SCU:“Yes”/Passenger's cell phone)

and

Pr MS)=Pr(SCU:“No”/Driver's cell phone)

are lower than the required threshold (for example 0.05).

In the following inequality:

$${\sum }_{i = 1}^{N} {δ}_{x m} \begin{matrix}{<}^{D} \\ {>}_{P}\end{matrix} {\sum }_{i = 1}^{N} {δ}_{ym}$$

(decision “Yes” or decision “No”), distance δ between values of PDFs or CDFs points at certain quantization regions of the four dimensional normalized observations power space is defined in a given manner as set out below.

Using “L2” criterion,

$${δ}_{x m} = {{\sum }_{k = 1}}^{4} {( {x}_{ik} - {m}_{ik} )}^{2} , {δ}_{y m i} = {\sum }_{k = 1}^{4} {( {x}_{ik} - {m}_{ik} )}^{2}$$

Using “L1” criterion,

$${δ}_{x m i} = {\sum }_{k = 1}^{4} \vert {x}_{ik} - {m}_{ik} \vert , {δ}_{y m i} = {\sum }_{k = 1}^{4} {\vert {y}_{ik} - {m}_{ik} \vert}^{2}$$

Using “Smirnoff” criterion,

$${max}_{i} {\vert F ( x ) - F ( m ) \vert}_{{>}_{P}}^{{<}^{D}} {max}_{i} \vert F ( y ) - F ( m ) \vert$$

Using Weighted L2 criterion,

$${δ}_{xmi} = {\sum }_{k = 1}^{4} {{f}_{m i k} ( {x}_{ik} - {m}_{ik} )}^{2} , {δ}_{ymi} = {\sum }_{k = 1}^{4} {{f}_{m ik} ( {y}_{ik} - {m}_{ik} )}^{2}$$

Using “Correlative” criterion,

$${δ}_{xm i} = \frac{{\sum }_{k = 1}^{4} {m}_{ik} {x}_{ik}}{\sqrt{{\sum }_{k = 1}^{4} {\sum }_{i = 1}^{N} {m}_{ik}^{2}} \sqrt{{\sum }_{k = 1}^{4} {\sum }_{i = 1}^{N} {x}_{ik}^{2}}} , \\ {δ}_{ymi} = \frac{{\sum }_{k = 1}^{4} {m}_{ik} {y}_{ik}}{\sqrt{{\sum }_{k = 1}^{4} {\sum }_{i = 1}^{N} {m}_{ik}^{2}} \sqrt{{\sum }_{k = 1}^{4} {\sum }_{i = 1}^{N} {y}_{ik}^{2}}}$$

Using “Max. likelihood-soft decision”=“MLSD” criterion,

$${δ}_{x m i } = {\sum }_{k = 1}^{4} ( {x}_{ik} - {m}_{ik} ) , \\ {δ}_{ym i} = {\sum }_{k = 1}^{4} ( {y}_{ik} - {m}_{ik} )$$

Using “Max. likelihood-hard decision”=“MLHD” criterion,

$${δ}_{xm i} = {\sum }_{k = 1}^{4} sign ( {x}_{ik} - {m}_{ik} ) , {δ}_{ym i} = {\sum }_{k 1}^{1} sign ( {y}_{ik} - {m}_{ik} )$$

Performance of the various criteria e.g. as illustrated above, depends on compatibility of training and measurement vectors which may, or may not, practically speaking, exist. Also. training data, as well as the observation results, are usually neither stationary nor ergodic, so averaging them may suffer from considerable deviation.
A so-called rank criterion, less sensitive to all these factors, may be employed. Due to certain localizations of antennae inside a car, their distances to the driver d_{d}=(d_{1d}d_{2d},d_{3d},d_{4d}) and to the passenger dₚ(d₁ₚ,d₂ₚ,d₃ₚ,d₄ₚ) may be estimated. Assume signals received by antennae have a Rice PDF with certain values of line-of-sight factor forming vector of Rician K-factors K=(K₁,K₂,K₃,K₄) depending on d_{d}, and dₚ and the strength of a multipath Raileigh distributed component.

The pdf, expressed in terms of the local-mean power P̅ and the Rician K-factor, is:

$${f}_{s} ( s ) = ( 1 + K ) exp ( - K - \frac{1 + K}{2 \overline{P}} {s}^{2} ) \frac{s}{\overline{P}} {I}_{0} ( \sqrt{\frac{2 K ( 1 + K}{\overline{P}}} s ) .$$

The pdf of signal power P may be derived from the PDF of signal amplitude s. For example, given

$$P = \frac{{s}^{2}}{2} ;$$

$${f}_{P} ( P ) = \frac{1 + K}{\overline{P}} exp ( - K - \frac{1 + K}{\overline{P}} P ) {I}_{0} ( \sqrt{4 K ( 1 + K )} \frac{P}{\overline{P}} ) .$$

Assume vectors d_{d}=(d_{1d},d_{2d},d_{3d},d_{4d}) and dₚ=(d₁ₚ,d₂ₚ,d₃ₚ,d₄ₚ) to be ordered such that d_{1d} <d_{2d}<d_{3d<}d_{4d} and d₁ₚ<d₂ₚ<d₃ₚ<d₄ₚ—in which case K₁>K₂>K₃>K₄. Then in the case of the training sequence x or y after averaging and normalizing of four antennae powers one of the following inequalities Pᵢ>Pⱼ>Pₖ>Pₗ may hold, where i,j,k,l∈[1÷4]. If training “driver” and “passenger” training sequence are of sufficient length, then, most frequently, inequalities P₁>P₂>P₃>P₄ and P₄>P₃>P₂>P₁ may hold, hence these inequalities may be said to be “typical sequences”. Other sequences typically occur with lower probability, but they may be separated into two groups: those “closer” to, and those “more distant from”, P₁>P₂>P₃>P₄ or P₄>P₃>P₂>P₁. Probability of all sequences (inequalities) may be computed in advance. Decision-creaking in real time may then comprise:

if the observed sequence Pᵢ>Pⱼ>Pₖ>Pₗ relates to the group of sequences closer to P₁>P₂>P₃>P₄, then the decision is “Driver”.

if the observed sequence Pᵢ>Pⱼ>Pₖ>Pₗ relates to the group of sequences closer to P₄>P₃>P₂>P₁, then the decision is “Passenger”.

“False Alarm” corresponds to the case that the vector of measurements m yields one of the sequences from the first group whereas in fact, the cell phone is in a passenger quadrant. A “Missed Signal” event occurs when m yields one of the sequences from the second group whereas in fact, the cell phone is in the driver's quadrant OR vicinity.

The number of different sequences in this case is 4!=24 and each of the first and second groups includes 12 sequences. If a fifth antenna is added, there may be 60 sequences in both groups which would decrease type 1 and type 2 errors. If all antennae have given deployments inside the car, the set of the corresponding power preference combinations may not depend on random changes in the electromagnetic environment during training or measurement stages, nor on the type of antennae, should this change.

The method described herein may use “main” antennae to locate the wireless device and at least one “reference” antenna. The system typically handles the changes of the wireless device power by adjusting the received power of the main antennae as opposed or relative to the received power of the reference antennae (e.g. if the power of the reference antenna decreases by x dB then the power of all the main antennae may be increased by x dB).

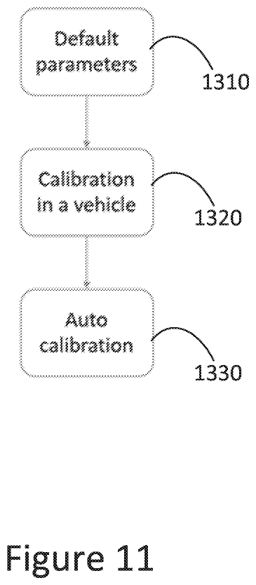

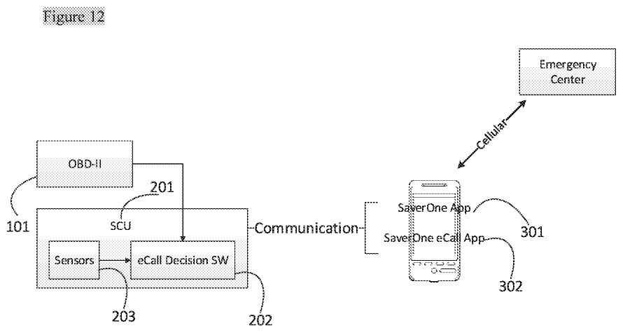

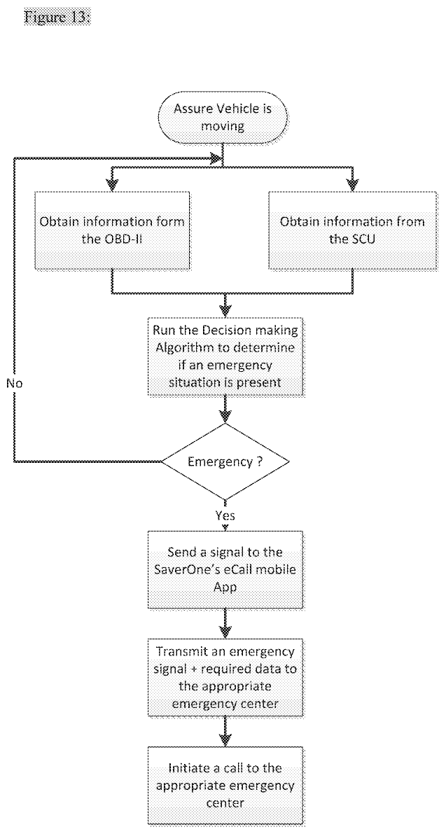

FIG. 11 is a simplified flowchart illustration of three calibration methods, any or all of which may for example be utilized in conjunction with the detailed localization process of FIGS. 10a-10c. The first method [13101] is based on default parameters which may be computed based on measurements taken from several vehicles during a set-up development process. The second method [1320] is based on a calibration process performed for a specific vehicle on which the system shown and described herein has been installed. Calibration for the above two methods may include locating the wireless device in known positions and collecting the data from all antennae, typically for a few minutes or even less. The third method [1330] is based on an online collection method that may continuously collect the data from the antennae and update the calibration parameters.

Locating a wireless device within a general volume as described in FIGS. 1-11 may be integrated with many applications and use-cases. For example, indoor location of cellular mobile phones may be used for indoor navigation, or for many location-based services. In addition, locating of wireless devices may be used also for safety and security purposes, such as prohibiting the use of peripherals of the phones at predefined locations or disabling hardware or software functionalities (e.g. applications) when these may endanger the user.

Locating a wireless device within a general volume as described in FIGS. 1-11 may be integrated with any of the embodiments of FIGS. 1-2 and 12 onward, in any suitable way. For example, locations of all wireless devices aka mobile communication devices in the vehicle may be computed at least one and typically more than once e.g. periodically e.g. once every few seconds or minutes where the period may be fixed or may depend on risk factors e.g. as described elsewhere herein. Alternatively or in addition the locations may be recomputed immediately upon occurrence of an emergency or a harbinger of an emergency, to provide additional information about the accident by determining for each wireless device temporarily within the vehicle's range e.g. temporarily in the vehicle, its last known position/location before the emergency and its first known position/location after the emergency. Such additional information may be used for example to reduce false positive emergency alerts e.g. if hand-held mobile communication devices are found not to have been jolted out of its previous place by the putative “accident”, vs. devices all found to have flown in the same direction as a result of the emergency—and/or to evaluate accident causes. E.g. a driver's use of her or his mobile communication device.

Referring again to FIGS. 12-13, the following embodiments and optional aspects and characterizations are included in the scope of the present invention and may, for example, be either added to or modify the embodiments of FIG. 12 and/or of FIG. 13:

The decision making that determines whether or not an emergency is present is typically run continuously or very frequently e.g. once per 1 or 5 or 10 or 20 or 60 or 300 or 600 seconds. Any suitable indication/s may be employed to determine that an emergency has occurred e.g. one or any suitable predetermined combination of the following events: deceleration exceeding a predetermined threshold value, changes in vehicle orientation suggesting the vehicle has overturned, indications of airbag deployment, and audio distress signals.

decision making that determines whether or not an emergency is present e.g. whether or not one or more of the above events has occurred may be based on sensors in the OBD and/or in the SCU and/or in the mobile phone.

It is appreciated that references to OBD-II are merely exemplary and may include any vehicular OBD system.

Any suitable technology for the emergency present yes/no decision making and for generating inputs thereto employing any suitable sensors such as but not limited to accelerometer/s, gyroscopes or microphones, may be employed, such as but not limited to any of the technologies taught by any of the following us patent documents, the disclosures of which are hereby incorporated by reference: Patent US20130273877—Automotive Accident Alert System; Patent US20110012720—Integration of Vehicle On-Board Diagnostics; Patent US20140300739—accident notification; Patent US20150166072; Patent US8676151—Detecting a transport emergency event; Patent US20130332026—Qualifying Automatic Vehicle Crash; Patent US20120123632—Crash Verification And Notification Of Call.

Any suitable eventuality may be pre-programmed to occur if and when an emergency is detected, such as but not limited to signaling a mobile app, transmitting data (including making a voice-call) to a remote entity (one or more) e.g. emergency center, generating an image of the emergency scene, and identifying mobile communication device holders adjacent the emergency scene, who are able to generate an image of the emergency scene.

The above eventualities may each or some or all be triggered or performed by any suitable controller's and/or processor's located on board the vehicle and/or or at a remote location; any suitable technology may be employed to convey an indication that an emergency has occurred, to the relevant controller/s and/or processor/s. For example, on-board software (e.g. module 202 described herein) in any of a set of vehicles within a population of vehicles, may activate (send an “emergency has occurred” indication, typically including a unique identifier of the vehicle and/or the location) to a mobile app/remote server which has been pre-programmed to recognize the on-board software (e.g. module 202) of each vehicle in the set, as a subscriber. The mobile app may in turn perform any or all of the above eventualities and/or may activate a remote server to perform any or all of the above eventualities. Any suitable subscribing process may be employed to enable vehicles in the vehicle population to become members of the vehicle set. For example, subscribing may include electronic confirmation of consent on the part of the owner of the vehicle to certain operations that are an invasion of privacy absent such consent.

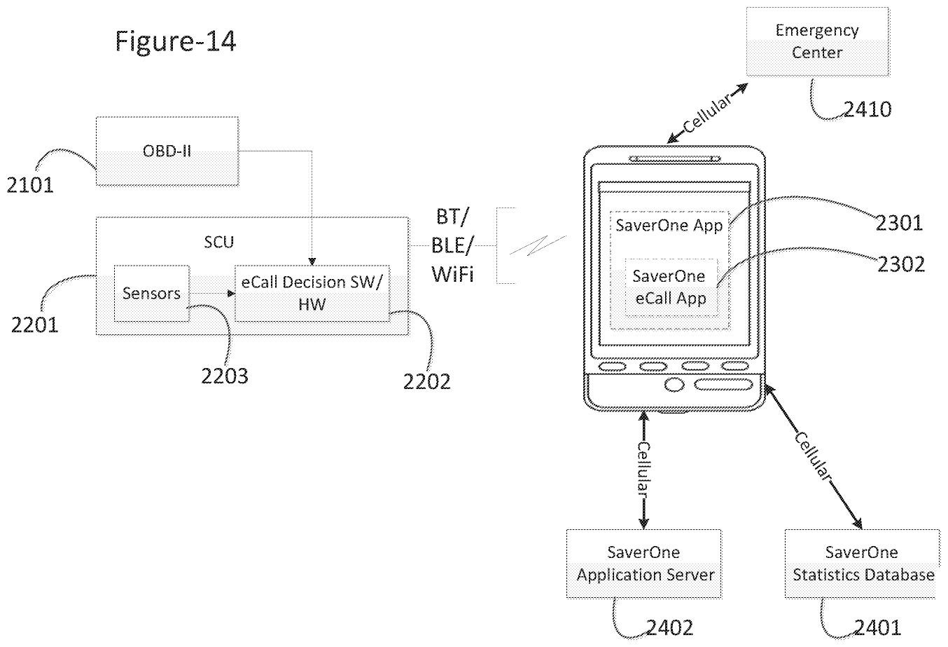

Referring now to the embodiments of FIGS. 14-16, the system of the present invention or SaverOne system may according to certain embodiments include any or all of
SaverOne System Control Unit (SCU) (2201)
eCall decision software/hardware (or more generally, emergency monitoring processor) (2202)
SaverOne system's sensors (2203)
SaverOne mobile application (2301)
eCall mobile application (2302)
SaverOne Statistics Database (2401)
SaverOne Application Server (2402)
Emergency Center (2410)

The eCall decision software/hardware (2202) (or more generally, emergency monitoring processor) can be located as part of the SCU (as can be seen in FIG. 14), or as a software that is installed in the mobile device.
The eCall decision software/hardware (2202) (or more generally, emergency monitoring processor) typically receives data from various sources which may include any or all of
   Vehicle OBD-II interface or similar interface to the vehicle or to any apparatus installed in the vehicle (2101): data may include any or all of speed, acceleration, direction, location, front/side collision, rollover, safety belt, air bags, lane shifting, collision warning, ESP (Electronic Stability System), etc.
   SaverOne System Control Unit—SCU (2201): data from SCU sensors (2203) that may include any or all of Location of the vehicle, its acceleration, its speed, mobile device location (within the vehicle) e.g, as determined by any of the embodiments of FIGS. 1-11, estimation of mobile device quantity and their characteristics (such as their operator type, their frequency band, their cellular wireless standard used concurrently or generally (2G/GSM, 3G/WCDMA/UNIMEISPA, 4G/WiMAX/LTE, etc.), etc,
   SaveOne application (2301)—data from the mobile device sensors, appliances or interfaces such as its camera, speakers, microphone, screen, audio volume, GPS sensor, acceleration sensor, magnetometer, etc.

Wireless or wired interfaces can be used in order to receive the abovementioned data from their sources to the eCall decision software/hardware (2202) (or more generally, emergency monitoring processor). Examples of wireless interfaces can be BT (BlueTooth), BLE, Wi-Fi and alike. For example, if the eCall. decision software/hardware (2202) (or more generally, emergency monitoring processor) is located at the SCU, then wireless interface (such as BT/BLE/Wi-Fi) can be used in order to receive the data from the SaveOne application (2301) which is part of the mobile device software. If the eCall decision software/hardware (2202) (or more generally, emergency monitoring processor) is located at the mobile device than wireless interface (such as BT/BLE/Wi-Fi are used to receive data from the SCU or OBD-II. Typically, single interface is used such as either one of BT/BLE/Wi-Fi) but sometimes there are cases where more than one interface is used concurrently (for example when higher reliability is required).

The eCall decision software/hardware (2202) (or more generally, emergency monitoring processor) runs any predetermined or any other decision algorithm and determines if an emergency situation is present, Example of such decision algorithm may be detection of event in the vehicle sensors (or any of its inputs) that is activated/changed in emergency situations such as: the activation of the air bags, drastic change in the velocity (speed) or acceleration of the vehicle (sharp deceleration that is typical to emergency situation such as in a collision event), etc. The algorithm may use single or any combination of these inputs to determine that emergency situation is apparent/present. It may use more than one input to increase the probability of correct decision.

SaveOne [mobile] application (2301) may be any mobile device application that is described in the co-pending patent application mentioned herein and/or any application that can control or monitor the mobile device sensors, appliances or interfaces such as its camera, speakers, microphone, screen, audio volume, GPS sensor, acceleration sensor, magnetometer, etc. or any application that have privileges to stop or activate any other application installed on the mobile device. Additional functionality of the SaveOne [mobile] application (2301) may be to enable the connectivity to the SCU or any apparatus installed in the vehicle that needs to be connected to the SaverOne application or any of its subsequent applications (such as eCall mobile application (2302)). Separately or as part of the SaverOne application (or included in it) there may be specific additional internal application that hereunder termed SaverOne's eCall mobile application (2302).

Mobile device can be cellular phone, smartphone, tablet, modem, laptop, pablet, smart watch, etc.

If an emergency situation is present (or some time before it or continuously during the ride, as will be elaborated hereunder), the SCU (2201) connects to the Driver's mobile device or to any other mobile device in the vehicle equipped with the SaverOne application via a communication link such as wired (e.g. if the mobile device is connected using wires to the infotainment system) or via wireless communication such as BlueTooth, BLE (BT Low Energy), Wi-Fi and alike. Typically, single interface/link is used (either BT/BLE/Wifi) but sometimes there are cases where more than one interface/link is used concurrently (in example when higher reliability is required). Thereafter, the eCall decision software/hardware (2202) (or more generally, emergency monitoring processor) instructs the SaverOne's eCall mobile application (2302) to perform all, one or any other suitable subset of the following tasks:
1. Send various parameters from the eCall decision software/hardware (2202) (or more generally, emergency monitoring processor) to the emergency center: location, speed of the vehicle, acceleration (to assist with evaluating event severity), vehicle make & model, vehicle license plate number, and other parameters. Alternatively, it can send any other standard data regarding eCall such as Minimum Data Set defined by the European eCall initiative or the 3GPP organization. For each of these parameters, the data that can be sent from each parameter may include its data from the several moments before the emergency situation or the last recorded value of the parameter)
2. Initiate a voice or video call to the designated emergency center or to any predetermined list of destinations. This may allow the emergency center personnel to talk with the driver even if he/she cannot reach the phone or is injured and can't operate it (typically by using SaverOne mobile application (2301) which may have the necessary privileges).
3. Send an emergency signal+geographic coordinates (that may be derived from the Drivers cellphone's GPS system) regarding the vehicle experiencing the emergency situation (this data may include the vehicle's current location and the location/speed/acceleration during some past time window) to SaverOne's application Server (2402). This task is optional.
4. Get logs from SaverOne's statistics database (2401) of the driver's mobile device in the vehicle experiencing the emergency situation. The log data may for example include driver behavior history (e.g. if the driver used his cellphone (while driving) before the emergency situation, did he disconnect the BT, the elapsed time from start driving etc. SaverOne's statistics database stores any data that is monitored by SaveOne application (2301) or sent by SaverOne application (2301) to eCall decision software/hardware (2202) (or more generally, emergency monitoring processor) as described above. The SaverOne's statistics database may be located as part of SaveOne application (2301), as part of SaverOne's application Server (2402) or as a separate server in the internet e.g. as shown in FIG. 14. These log/s may include any relevant parameter and a timestamp of a predefined number of seconds prior to the emergency situation. The log may include any or all of: the phone number or other unique identifier of the driver mobile device, the vehicle location, the position or location of the mobile device in the vehicle, estimated number of mobile devices in the vehicle, attempts to use non-allowed applications and time elapsed since start-driving.

The emergency center, upon receiving the data from the various sources (any, some or all) SaverOne SCU (2201), SaverOne application (2301), eCall decision SW/HW (2202), SaverOne Application Server (2402) and SaverOne's statistics database (2401) may analyze the data and provide conclusions and recommendations to relevant agencies these may include law enforcement, medical, fire, road assistance and insurance agencies.

An emergency situation may for example include or consist of any situation which requires a rapid intervention. A need for emergency medical care is one example of such a situation. A need to promptly document a traffic accident's outcome is another example of such a situation.

Receiving parameters from the OBD-II (2101) and from SaverOne SCU (2201) and from the SaverOne mobile application (2301) creates redundancy and increases the reliability of data processed by the eCall decision software/hardware (2202) (or more generally, emergency monitoring processor).

Receiving parameters from the various sources increases the chances of maximal data transferred to the emergency center, supporting efficient and accurate analysis and decision making regarding emergency situation status, or proper analysis of accident. The SCU or the eCall decision software/hardware (2202) (or more generally, emergency monitoring processor) may use the SaverOne mobile application (2301) and the sensors (2203) to ensure that the driver's cellphone has connection with the SCU (2201) or the eCall decision software/hardware (2202) (or more generally, emergency monitoring processor) and to assure that the SaverOne's eCall mobile application (2302) is running in the driver's mobile device. The functionality offered by this system assures this, and verifies that in an emergency situation the required call and transfer of required parameters may be carried out.

By knowing the vehicle's location, the suitable emergency center can be called, e.g. the closest emergency medical care facility, creating efficient operation and increasing chances for effective rescue, during the “golden hour”.

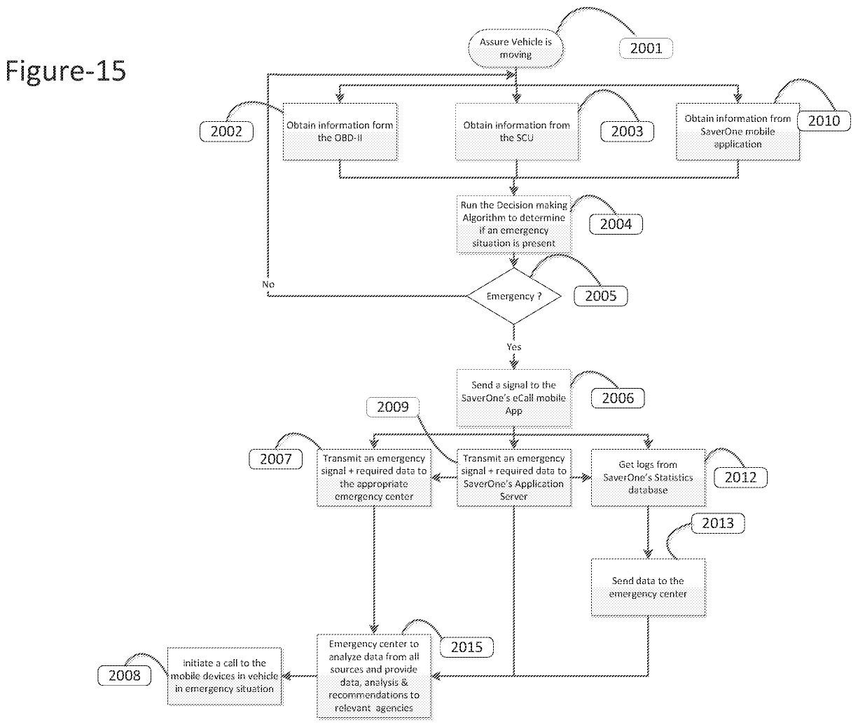

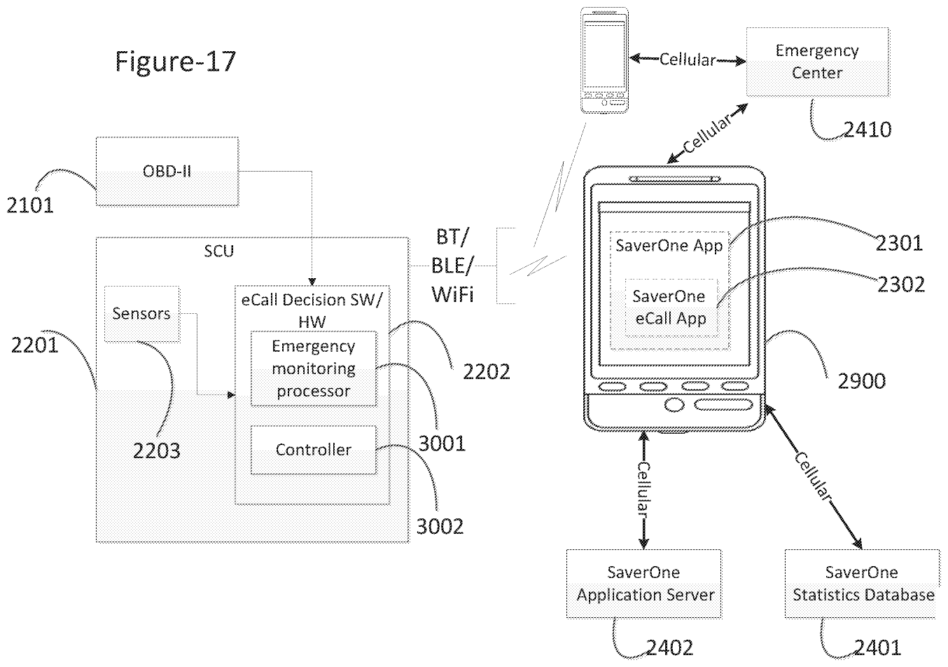

The system operation process is now described with reference to FIG. 15. The process includes some or all of the following operations, in any suitable order e.g. as shown:
2001: The eCall decision software/hardware (2202) (or more generally, emergency monitoring processor) receives data from various sources which may include any or all of the Vehicle OBD-II interface or similar interface, to assure the vehicle is moving
2002-2003: The eCall decision software/hardware (2202) (or more generally, emergency monitoring processor) may obtain information/data from various sources such as the OBD-II (2002), SaverOne mobile application (2301) and the System Control Unit (SCU) (2003)
2004-2005: The eCall decision software/hardware (2202) (or more generally, emergency monitoring processor) runs the decision-making algorithm to determine if an emergency situation is present (2005) using the information/data from the various sources.
2006: If an emergency situation is present, the SCU (2201) or the eCall decision software/hardware (2202) is connected by a controller to the SaverOne mobile application (2301) in the Driver's mobile device or any other mobile device in the vehicle equipped with the SaverOne application via wireless communication such as BlueTooth, BLE or Wi-Fi and typically instructs the SaverOne's eCall mobile application (2302) to perform all or any subset of several tasks described next. It may be noted that the connection that the controller established between the the SCU (2201) or the eCall decision software/hardware (2202) connects to the SaverOne mobile application (2301)) e,g. using any of the embodiments of FIGS. 17-20. can be made also some time before the emergency situation happened or even continuously during the ride, e.g. in accordance with any of the embodiments described in detail hereinbelow.
2007: SaverOne's eCall mobile application (2302) may transmit an emergency signal+required data to the appropriate emergency center,
200S: The emergency center may Initiate a call to mobile devices in vehicle in emergency situation
2009: SaverOne's eCall mobile application (2302) may transmit an emergency signal+required data to SaverOne's Application Server (2402), Thereafter optionally the SaverOne's Application Server (2402) can send/transmit the emergency alert and relevant data to the emergency center (this send/transmit may be instead or in addition to the SaverOne's eCall mobile application (2302) transmission to the appropriate emergency center—step 2007 above)
2012: SaverOne's eCall mobile application (2302) or SaverOne's Application Server (2402) may get logs from SaverOne's Statistics database.
2013: SaverOne's eCall mobile application (2302) or SaverOne's Application Server (2402) may then Send the data to the emergency center
2015: The emergency center may analyze data from any or all the sources and provide data, conclusions & recommendations to relevant agencies—these may include law enforcement, medical, fire, road assistance and insurance agencies,

Obtaining immediate data characterizing an accident or emergency, e.g. as described herein, and analyzing, in real time and/or later, off-line, the accident's or other emergency's causes and outcomes and understanding the events that occurred prior, at and after the accident is of importance to various computerized organizations and networks such as but not limited to caregivers, safety agencies, insurance parties and municipalities/governmental parties.

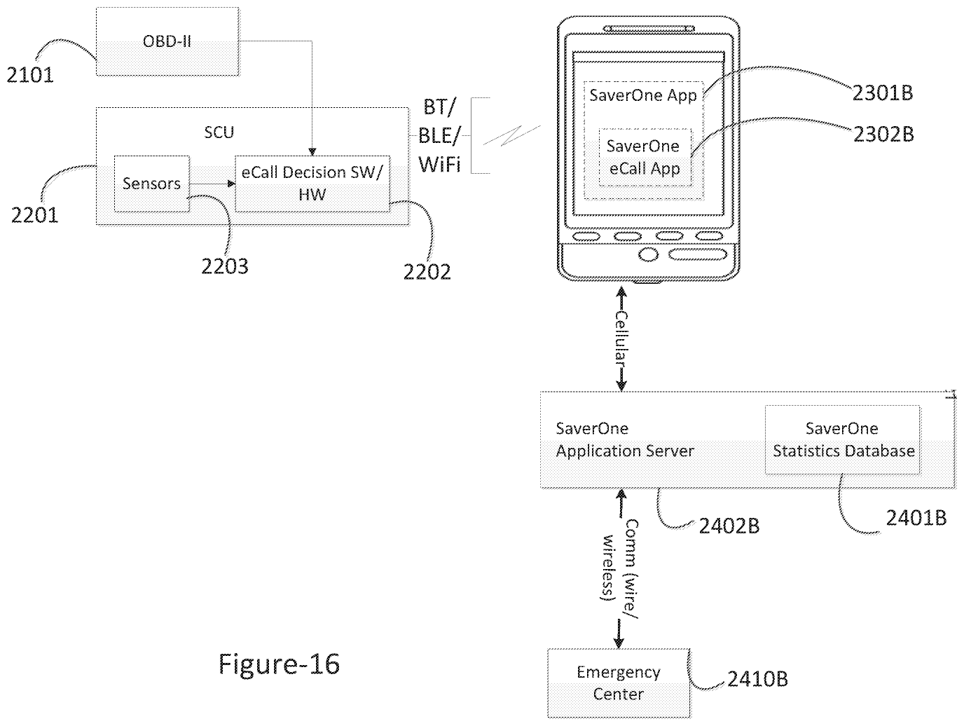

FIG. 16 presents another example configuration of system elements which may be used instead of the example embodiment of FIG. 14. In this example system architecture, the SaverOne statistics database (2401B) is part of the SaverOne Application Server (2402B). alternatively, or in addition the SaverOne Application Server (2402B) is the entity that is connected to the emergency center (2410B). The configuration of FIG. 16 may decrease the load on the mobile device in the emergency situation since the mobile device may connect only to SaverOne Application Server (single point of contact) that is responsible to send the alert and relevant information/data to the emergency center (2410B).

FIGS. 17-20 describes several additional embodiments regarding several elements in the system and the process of connectivity between eCall decision software/hardware (2202) and between SaverOne mobile application (2301) or SaverOne's eCall mobile application (2302). As shown, the system may include Emergency monitoring processor aka EMP (3001/3001B) and/or Controller (3002/3002B). There are several system configurations for the location of these elements in the systems as can be seen in the four alternative system configurations illustrated in FIGS. 17-20 respectively.

FIG. 17 presents a general system configuration e.g. similar to that described herein with reference to FIG. 14 where the mobile device connects via cellular directly to the Emergency center (2410) and to application server (2402) and to statistics database (2401). The EMP (3001) and the Controller (3002) in FIG. 17 are part of the eCall Decision SW/HW (2202). The EMP (3001) may be operative to receive and collect (aggregate) some or all data generated from various sources of data useful for determining whether or not an emergency situation has occurred. This data may be generated, in example, by one or more of the OBD-II (2101), SCU sensors (2203), mobile device (2900) sensors or any other data generating source on-board the vehicle.

Thereafter, the EMP applies suitable decision logic or a suitable decision algorithm to the received data in order to compute/derive relevant information regarding the emergency situation, aka Emergency Relevant Infomiation=ERI, which may for example include sonic or all of:
a. decide whether or not an emergency situation has happened and also, optionally, the probability of correctness or reliability of or level of confidence in, this decision.
b. compute risk/probability that an emergency situation is imminent, using predetermined rules. For example, the risk of emergency may be deemed higher than normal if vehicle velocity is very high or if vehicle acceleration is varying rapidly or if the road section is known to he dangerous.

This ERI is then passed to the Controller (3002) which is typically operative to trigger the mobile phone cellular communication link so that emergency situation data/alert/information is transmitted to the Emergency center/s (2410) and/or to other typically pre-programmed destinations. The Controller (3002) may use relevant parameters from the ERI to decide when to establish and for how long to maintain a link from the SCU (2201) communication element (e.g. BT/BLE/WiFi modem) to the mobile device (2900) parallel communication element (in example BT/BLE/WiFi modem).

First, according to certain embodiments, a link is established between the Controller (3001) and the SaverOne eCall app (2302) which is part of SaverOne app (2301). SaverOne eCall app (2302) then connects using the cellular modem/network to the Emergency center (2410). Typically after the following two links are established:

1/“first connection”/“local connection”=between the SCU and the mobile device,

2/“second connection”/“remote connection”=between the mobile device and the Emergency center

the relevant Emergency Situation Message/s (aka called ESM) may be sent from the eCall decision SW/FIW (2202) through the mobile device (2900) to the emergency center (2410).

The link between the SCU and the mobile device may be established for example only when an emergency situation is detected. Alternatively this link may be established prior to a detection of emergency situation, e.g. if the risk of an emergency situation happening in the near fixture is higher than a threshold. In order to evaluate that risk, the Controller (3002) may use the relevant part of the ERI provided on occasion (continuously or from time to time or responsive to a trigger from other element such as the controller itself) by the EMP (2202).

The Controller (3002) may decide to establish the local connection to one or more mobile devices concurrently (e.g., in FIG. 17, to two mobile devices). Controller (3002) may use an algorithm to decide what is the best order of connections to establish between the SCU local connection modem (BT/BLE/WiFi. in example) and the different mobile devices located within or adjacent to the vehicle. For example, Controller (3002) may decide to send the ESM using all mobile devices in the vehicle. Alternatively, e.g. if there is a constraint that forces sequential connections to be made (rather than parallel) Controller (3002) may decide to use a priority decision algorithm to decide the optimal order of connection to be made in this local connection. Input information serving this priority algorithm may include information passed from the mobile device (e.g. from the SaverOne app (2301)) and/or from SaverOne eCall app (2302) to the SCU (2201) or to elements thereof such as the Controller (3002)).

One example of a suitable priority algorithm is to use first (prioritize) the mobile devices whose remote connection enjoy the best link status (e.g. higher Signal-to-noise ratio). Alternatively, send first using mobile devices in each of several different sub-bands and only then send again using other mobile devices using “already represented” sub-bands. Alternatively the mobile devices may be utilized in random order (no fixed priority at all).

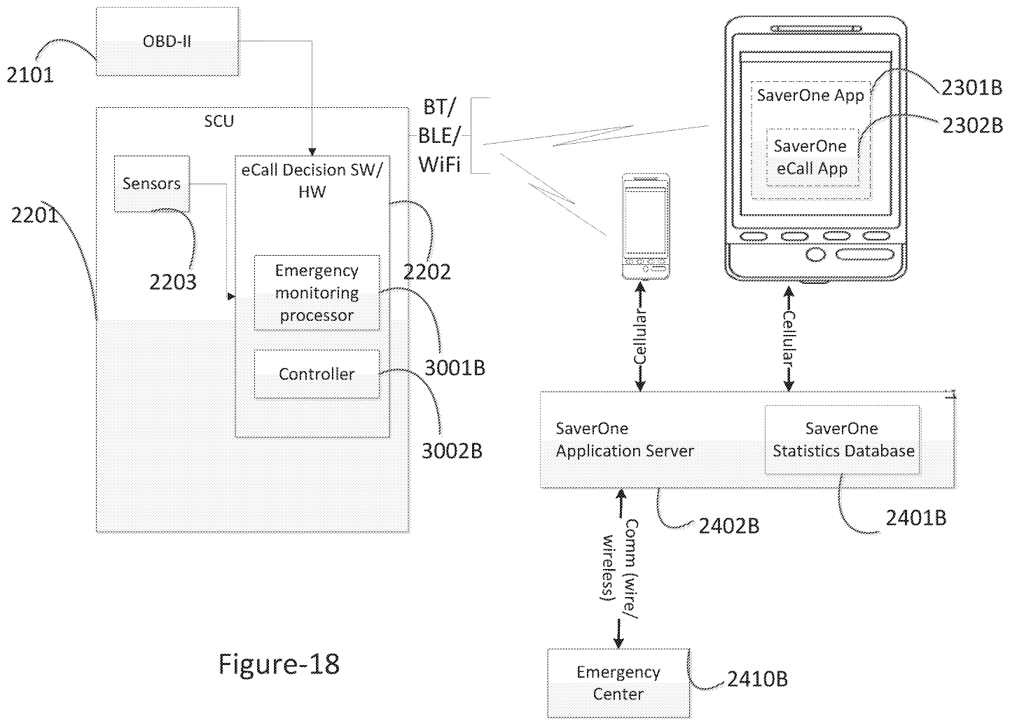

FIG. 18 illustrates the EMP (3001B) and Controller (3002B) for a system configuration similar to that of FIG. 16. The description above of FIG. 17 may be implemented in this configuration as well.

It is appreciated that any suitable logic may govern the process for deciding which mobile communication device/s to use and this determination may be made at any suitable time or times, the specific implementations described herein being merely by way of example. Also, once it has been decided which we decided which device/s to use, any suitable process may be used for establishing that controller-phone link, at any suitable time/s.

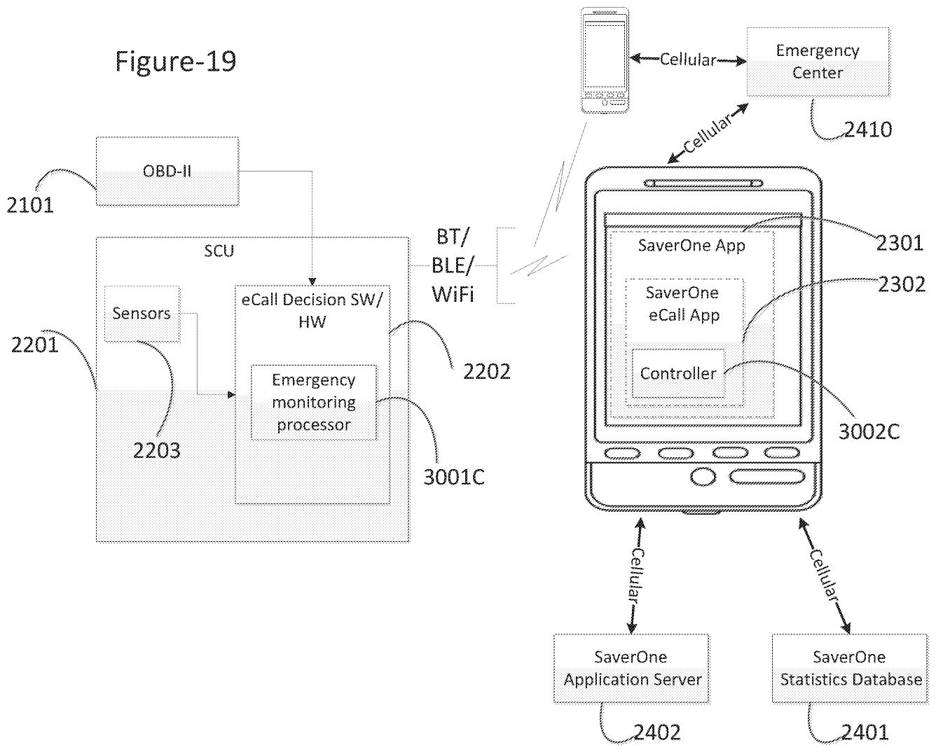

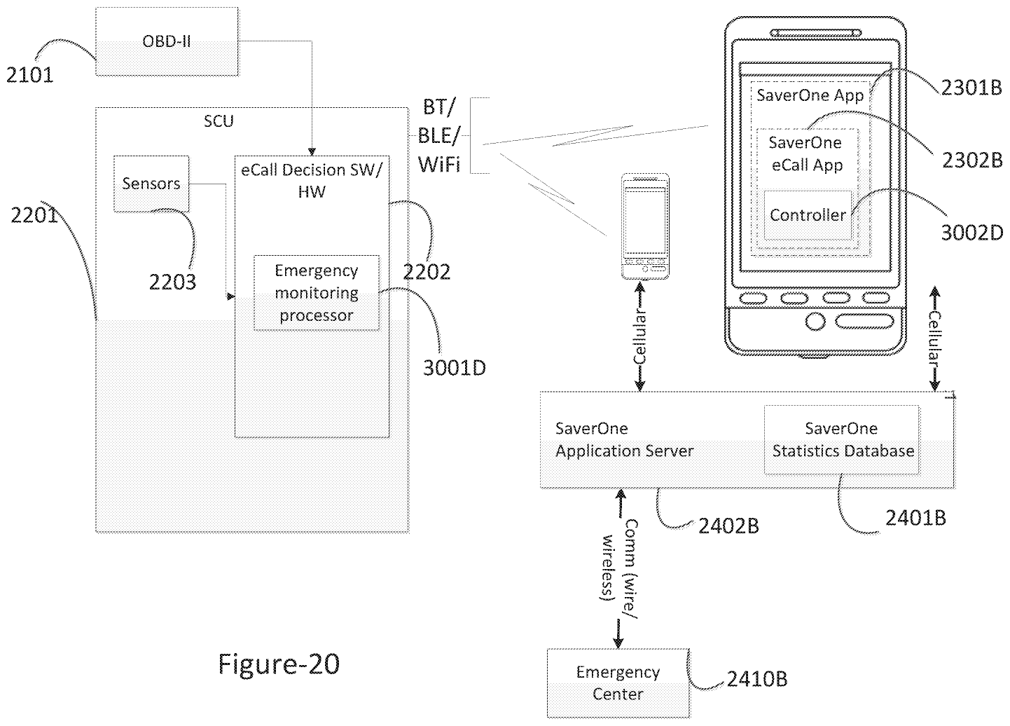

FIGS. 19-20 present additional alternative system configurations in which the controller is S implemented within the ecall app.

In the alternative system configurations, in which some of or all the internal elements (such as EMP and Controller) are not provided as part of the SCU, the local connection may be established between other system elements. For example, in FIGS. 17-18 local connection is between the Controller (3002/3002B) and SaverOne app (2301/2301B)/SaverOne eCall app (2302/2302B). In FIGS. 19-20, EMP (3001C/3001D) is part of the SCU (for example part of its internal eCall decision SWIM (2202)) whereas Controller (3002c/3002D) is part of the mobile device (e.g. part of the SaverOne Call app (2302/2302B). Therefore in these system configurations the local connection is between the EMP (3001C/3001D) and the Controller (3002C/3002D) using the local link (e.g. through the BT/BLE/WiFi modems of the SCU and the mobile device accordingly).

According to some alternative system configurations, both the EMP and the Controller may be part of the mobile device. In this configuration the local connection may be established between the SCU (between one of the SCU's elements, e.g. the eCall decision SW/HW) and the EMP that is part of the mobile device; the EMP may be integrated within, say, the SaverOne app or the SaverOne eCall app. In this case the EMP may use the local connection to get data from vehicle data generators e.g. the OBD-II or sensors of the SCU. The EMP may deliver the EIR to the Controller that may also be part of the mobile device. Upon detection of an emergency situation, the Controller may trigger and distribute information (e.g. ESM) to remote destinations e.g. emergency center/s.

There may be several agencies to which an emergency alert and/or relevant data is sent The connection to each of them may be prioritized according to the relevance and importance of the event to them. For example, if a severe accident is estimated then a medical agency may be alerted first. If a mild accident is estimated than the insurance agency or police may be alerted in high priority as well.

The SCU shown and described herein may include:

data receiving (passive, or active aggregation) functionality e.g. an Emergency monitoring processor which receives data from at least one source including at least one vehicle-mounted source and repeatedly determines, based at least partly on at least sonic of the data, whether or not an emergency situation is present; and/or

a controller which is operative, e.g. if an emergency situation is detected, to scan the vehicle for mobile communication devices including identifying at least one mobile communication device temporarily within the vehicle's range e.g. temporarily present in the vehicle and to trigger at least one mobile communication device thus identified to distribute data regarding the emergency situation to at least one remote destination; and/or

mobile communication device localization (within the vehicle) functionality e.g. as per any of the embodiments of FIGS. 1-11.

Emergency monitoring functionality may include data receiving (passive, or active aggregation) functionality which receives data from at least one source including at least one vehicle-mounted source. For example, active aggregation may include polling data source/s e.g. the OBD-II and/or at least one mobile phone and/or within-vehicle mobile phone localization functionality e.g. the functionality of FIGS. 1-11 and/or other available sensors for data. And/or may include filtering of a stream of data from one or more data sources e.g. sensors.

The active embodiment or option may include the SCU periodically requesting data/status from, say, sensors or OBD-II (e.g. air bag status, crash detection status).

The passive embodiment or option may include the SCU sniffing information from the OBD-II or other sensors that transmit their status periodically or after car crash.

It is appreciated that a particular advantage of utilizing passenger (including driver) cellphones to distribute data regarding an emergency situation rather than utilizing a special vehicular modem is that the need to provide vehicular modems greatly increases the density of cell modems in the field. For example, if each vehicle is populated with 1 or 2 or 3 mobile phones on average, adding a modem per vehicle may increase the density of cell modems two-fold or by 50% or by 33%. This additional burden is heavy and causes either added costs to cellular operators having to expand the cellular infrastructure, or poor service due to the increased load on the cellular links, particularly in non-city regions such as highways in which cell towers (base stations) arc relatively sparsely deployed relative to deployment in metropolitan areas.

It is appreciated that the particular controller or SCU handshake with the modem shown and described herein is not intended to be limiting and any suitable modification thereof may be implemented.

It is appreciated that the controller or SCU may be preprogrammed to send in the emergency situation notification via all available modems (all available cells identified in the vehicle) or via only one such or only n such (e.g. n=2).

It is appreciated that some data regarding the emergency (e.g. the mere binary fact that an emergency has been detected and/or its location and/or its time-stamp) may be sent from all available modems/phones whereas other data regarding the emergency e.g. the estimated number of persons in the car (which may e.g. be estimated by estimating the number of cellphones in the vehicle), estimated severity and other characteristics of the emergency may be sent only from one of the phones or only n such, Available phones are typically identified by performing a local scan of the vehicle, e.g. using Wi-Fi or Bluetooth, recording those phones which are responsive and establishing a link with one, some or all of them. If less than all are selected, a random subset of available phones of a predetermined size (e.g. n=2) may be selected or the first n phones identified may be used or any criterion of bestness may be employed e.g. preferring the driver's cellphone or conversely preferring the cellphone of a back-seat passenger or the front-seat non-driving passenger. The local scan may be performed at any suitable time and/or any suitable periodicity beginning from an initial time e,g. as soon as the vehicle ignites, as soon as the door opens, upon detection of an emergency, or upon detection of harbinger/s of an emergency such as deceleration (or a pattern of accelerations) which is not yet indicative of an emergency but is still more extreme than normal deceleration or normal acceleration patterns Establishing a link (handshake) between the controller and the selected phone/s may occur either immediately after the local scan, or only upon detection of an emergency, or only upon detection of harbinger/s of an emergency e.g. as described above. Handshaking early (e.g. right after the local scan) means that any emergency is reported more quickly which may be advantageous either to ensure rapid response and/or to timely utilize a cellphone “in flight” due to the accident—before that cellphone, perhaps, exits the vehicle or breaks due to uncontrolled impact with a hard object. Handshaking late (e.g. only upon occurrence of an emergency or at least only upon occurrence of a harbinger of an emergency) is advantageous because it is less burdensome to the cellphone's (and controller's) battery since no open controller-cellphone communication link is being maintained.

It is appreciated that the controller or SCU may be a hardware device, typically lacking a cell modem to save equipment deployment cost and/or monthly cellphone provider subscription fees. The device may be on board the vehicle or may be incorporated within a mobile device borne by persons driving or traveling in the car and may have any suitable type of communication with the vehicle's OBD-II and/or with cellphones in the vehicle,

It is appreciated that any suitable protocol may be developed and shared between the system shown and described herein and remote locations receiving emergency notifications, to transmit emergency data uniformly to a remote location.

The controller's (e.g. SCU's) power may be provided by the vehicle itself or by an emergency battery serving the controller,

It is appreciated generally that the term “ecall app” may be interpreted herein to refer to functionality, within a cell app, which allows on-board data to be conveyed to remote locations via mobile devices which are temporarily within vehicle range. The cell app may however also have other functionalities, e,g. any of the functionalities described in the co-pending published pct application referenced herewithin. So, the terms “saverOne app” and “SaverOne eCall app” as used herein may be implemented, in practice, as a single cell app which has on the one hand any of the functionalities described in the co-pending published pct application referenced herewithin and on the other hand on-board data to be conveyed to remote locations via mobile devices which are temporarily within vehicle range in accordance with any embodiment described herein.

The terms “wireless device”, “cellphone”, “smartphone”, “radiating device” “mobile (communication) device”, “transmitting device” and similar, as used herein are intended to include but not be limited to any of the following: mobile telephone, smart phone, playstation, iPad, TV, remote desktop computer, game console, tablet, mobile e.g. laptop or other computer terminal, embedded remote unit.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may he wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (h) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones, may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, be able to modify the device to obtain the structure or function.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. A system for conveying data generated on-board a vehicle, from the vehicle to at least one remote location/s, the system comprising:
An on-board data monitoring processor which receives data from at least one data-generating source including at least one vehicle-mounted data-generating source; and
a controller which is operative, at least on occasion, to scan the vehicle for mobile communication devices thereby to identify at least one mobile communication device temporarily within the vehicle's range and to trigger at least one mobile communication device thus identified to convey at least some of the data received from the at least one source to at least one remote destination.

2. A system according to claim 1 wherein said data which at least one mobile communication device is triggered to convey, comprises an indication that an emergency has occurred.

3. A system according to claim 1 wherein said data which at least one mobile communication device is triggered to convey, comprises an indication of emergency type e.g. deceleration, airbag activation, vehicle overturned.

4. A system according to claim 2 wherein said data which at least one mobile communication device is triggered to convey, comprises a time-stamp characterizing at least one event relevant to said emergency.

5. A system according to claim 2 wherein said data which at least one mobile communication device is triggered to convey, comprises a location relevant to said emergency.

6. A system according to claim 1 wherein said data which at least one mobile communication device is triggered to convey, comprises an estimated number of mobile communication devices in the vehicle.

7. A system according to claim 1 wherein said data which at least one mobile communication device is triggered to convey, comprises vehicle diagnostic data.

8. A system according to claim 1 wherein said processor repeatedly determines, based at least partly on at least some of said data, what data to convey if at all.

9. A system according to claim 1 wherein one occasion on which the controller is operative to scan the vehicle is that the processor made a determination that data should be conveyed to the remote location/s.

10. A system according to claim 9 wherein the controller is operative to scan the vehicle only when the processor has made a determination that data should be conveyed to the remote location/s.

11. A system according to claim 1 wherein one occasion on which the controller is operative to trigger at least one mobile communication device to convey data is that the processor made a determination that data should be conveyed to the remote location/s.

12. A system according to claim 11 wherein the controller is operative to trigger at least one mobile communication device to convey data only when the processor has made a determination that data should be conveyed to the remote location/s.

13. A system according to claim 1 wherein the controller is operative to scan the vehicle for mobile communication devices thereby to identify at least one mobile communication device temporarily within the vehicle's range and to trigger at least one mobile communication device thus identified to convey at least some of the data received from the at least one source to at least one remote destination, at least when an emergency situation is detected by said processor.

14. A system according to claim 1 wherein the at least one data-generating source includes at least one of:
a sensor such as but not limited to camera or imager, microphone, accelereometer, odometer, thermostat, which may or may not be wearable and may or or may be an obd sensor,
an electronic component or logic generating output data such as but not limited to an electronic or software or firmware diagnostic component;
a tester e.g. BIT.

15. A system according to claim 1 wherein the processor comprises an Emergency monitoring processor which receives data from at least one source including at least one vehicle-mounted source and repeatedly determines, based at least partly on at least some of said data, whether or not an emergency situation is present.

16. A system according to claim 1, wherein the controller is operative, if an emergency situation is detected by said processor, to scan the vehicle for mobile communication devices thereby to identify at least one mobile communication device temporarily within the vehicle's range and to trigger at least one mobile communication device thus identified to distribute data regarding said emergency situation to at least one remote destination.

17. A system according to claim 1 wherein the system is operative for automatically contacting at least one emergency center and wherein the processor is incorporated into call decision software which receives data from at least one vehicle-mounted source and determines, based at least partly on at least some of said data, whether or not an emergency situation is present and wherein the controller comprises an SCU which is operative, if an emergency situation is detected, to connect to the Driver's mobile and to send a signal, to an eCall mobile application residing on the driver's mobile which is connected to a cellular network, instructing the eCall mobile application to contact at last one designated emergency center, via the cellular network.

18. A method for conveying data generated on-board a vehicle, from the vehicle to at least one remote location/s, the system comprising:
using an on-board data monitoring processor to receive data from at least one data-generating source including at least one vehicle-mounted data-generating source; and
at least on occasion, scanning the vehicle for mobile communication devices thereby to identify at least one mobile communication device temporarily within the vehicle's range and triggering at least one mobile communication device thus identified to convey at least some of the data received from the at least one source to at least one remote destination.

19. A computer program product, comprising a non-transitory tangible computer readable medium having computer readable program code embodied therein, the computer readable program code adapted to be executed to implement a method for conveying data generated on-board a vehicle, from the vehicle to at least one remote location/s, the system comprising:
using an on-board data monitoring processor to receive data from at least one data-generating source including at least one vehicle-mounted data-generating source; and
at least on occasion, scanning the vehicle for mobile communication devices thereby to identify at least one mobile communication device temporarily within the vehicle's range and triggering at least one mobile communication device thus identified to convey at least some of the data received from the at least one source to at least one remote destination.
